(19) United States
(12) Patent Application Publication
(10) Pub. No.: US 2025/0211416 A1
(43) Pub. Date: Jun. 26, 2025

(54) COMPUTE ENGINE CONTROL BLOCK (CCB) DISTRIBUTED DATA WORD ARCHITECTURE

(71) Applicant: Intel Corporation, Santa Clara, CA (US)

(72) Inventors: Christopher B. WILKERSON, Vancouver, WA (US); Adish VARTAK, Palo Alto, CA (US); Sanu K. MATHEW, Portland, OR (US); Raghavan KUMAR, Hillsboro, OR (US); AppaRao CHALLAGUNDLA, Austin, TX (US)

(21) Appl. No.: 18/395,272

(22) Filed: Dec. 22, 2023

(51) Int. Cl. H04L 9/00

(52) U.S. Cl. CPC H04L 9/008

(57) ABSTRACT

Compute circuitry to perform Fully Homomorphic Encryption (FHE) includes a memory system and a compute engine. The compute engine includes tiles organized in an array. The array of tiles in the compute engine provides compute elements to perform polynomial operations for polynomials. Synchronization support is provided by a Compute Engine Control Block (CCB) in the compute circuitry. The Compute Engine Control Block decomposes large data word loads and stores (with data spread across memory channels) into smaller requests for each memory channel. The Compute Engine Control Block uses completion signals received from each memory channel to assess the completion state of the large data word load/store. The Compute Engine Control Block to manage instruction dispatch across all tiles in the array of tiles and to ensure the tiles in the compute engine to operate in lockstep to enable synchronization free communication between the tiles.

### STATEMENT REGARDING FEDERALLY SPONSORED RESEARCH

This invention was made with Government support under contract number HR0011-21-3-0003 awarded by the Department of Defense. The Government has certain rights in this invention.

### BACKGROUND

Homomorphic encryption is a form of encryption that allows computations to be performed on encrypted data without first having to decrypt it. The computations are performed on polynomials. The degree of a polynomial is the highest of the degrees of the polynomial's individual terms with non-zero coefficients. The degree of a term is the sum of the exponents of the variables in the term. The degree of the polynomial is the highest exponent in the polynomial.

For example, the polynomial 5x⁴+3x−10 has three terms, one variable x and three coefficients (number that is being multiplied by a variable). The first term has a degree of 4, the second term has a degree of 1 and the third term has a degree of 0. The polynomial has a degree of 4 (the highest exponent of the terms in the polynomial).

Fully Homomorphic Encryption (FHE) enables computation on encrypted data, or ciphertext, rather than plaintext, or unencrypted data, keeping data protected at all times. FHE uses lattice cryptography, which presents complex mathematical challenges to would-be attackers.

FHE standards support a wide range of polynomials, with the degree of the polynomial ranging from 1024 (1K) up to 128K and where each coefficient in the polynomial can range from 32 bits up to 2K bits dependent on the degree of the polynomial.

### BRIEF DESCRIPTION OF DRAWINGS

Various examples in accordance with the present disclosure will be described with reference to the drawings, in which:

FIG. 1 illustrates an example system;

FIG. 2 illustrates an example of a fully homomorphic encryption accelerator;

FIG. 3 is a block diagram of a polynomial used by the FHE accelerator to perform FHE computations;

FIG. 4 is a block diagram illustrating distribution of the elements of the polynomial shown in FIG. 3 in the FHE accelerator and the compute engine control block to execute instructions in lockstep across the tiles in the compute engine;

FIG. 5 is a block diagram illustrating dispatch of instructions by the compute engine control block in the FHE accelerator;

FIG. 6 is a block diagram illustrating the Minst dispatch, Cinst Dispatch and Xinst dispatch in the compute engine control block.

FIG. 7 is a flowgraph illustrating dispatch of Minst on the Cinst/Minst data path in the compute engine control block;

FIG. 8 is a flowgraph illustrating dispatch of Cinst on the Cinst/Minst data path in the compute engine control block and Xinst on the Xinst data path;

FIG. 9 is a block diagram illustrating use of memory instructions (Minst) to perform data transfer between HBM and scratch pad memory;

FIG. 10 is a block diagram of the compute engine control block illustrating pointers and indices used for synchronization support to manage instruction dispatch across all of the Compute Engine Control Block tiles and to ensure the compute engine tiles are operating in lockstep;

FIG. 11 illustrates examples of an instruction format;

FIG. 12 illustrates an example computing system;

FIG. 13 illustrates a block diagram of an example SoC that may have one or more processor cores and an integrated memory controller;

FIG. 14(A) is a block diagram illustrating both an example in-order pipeline and an example register renaming, out-of-order issue/execution pipeline according to examples;

FIG. 14(B) is a block diagram illustrating both an example in-order architecture core and an example register renaming, out-of-order issue/execution architecture core to be included in a processor according to examples;

FIG. 15 illustrates examples of execution unit(s) circuitry;

FIG. 16 is a block diagram of a register architecture according to some examples;

FIG. 17 illustrates examples of an addressing information field;

FIG. 18 illustrates examples of a first prefix;

FIGS. 19(A)-(D) illustrate examples of how the R, X, and B fields of the first prefix in FIG. 18 are used;

FIGS. 20(A)-(B) illustrate examples of a second prefix;

FIG. 21 illustrates examples of a third prefix; and

FIG. 22 is a block diagram illustrating the use of a software instruction converter to convert binary instructions in a source instruction set architecture to binary instructions in a target instruction set architecture according to examples.

### DETAILED DESCRIPTION

Compute circuitry to perform Fully Homomorphic Encryption (FHE) includes a memory system and a compute engine. Compute circuitry to perform Fully Homomorphic Encryption also includes dedicated data movement techniques (point-to-point or 2D-Mesh interconnect) to shuffle the coefficients during Number-Theoretic-Transforms (NTT) and inverse-NTT (iNTT) operations, which are critical operations in a FHE workload.

The compute engine includes 64 tiles organized in an array with 8 rows and 8 columns. Each tile has 128 compute elements, the array of 64 tiles in the compute engine provides 8192 (8K) compute elements to perform 16K polynomial operations. The 64 tiles in the compute engine communicate with different independent portions of the memory system. For the compute engine to act as a single unified execution resource, instruction dispatch and memory requests must be carefully timed/coordinated so that different tiles and portions of the memory system are in sync. NTT and iNTT are examples of tasks in FHE workloads that require coordination between tiles.

With each tile and portion of memory that the tile communicates with operating independently, tiles need to provide synchronization support between each other before performing tasks that require coordination between tiles.

Synchronization support is provided by a Compute Engine Control Block (CCB) in the compute circuitry. The Compute Engine Control Block decomposes large data word loads and stores (with data spread across memory channels) into smaller requests for each memory channel. The Compute Engine Control Block uses completion signals received from each memory channel to assess the completion state of the large data word load/store. The Compute Engine Control Block uses the completion signals to manage instruction dispatch across all of the Compute Engine Control Block tiles. The Compute Engine Control Block manages instruction dispatch across all tiles in the array of tiles and ensures the tiles in the compute engine operate in lockstep to enable synchronization free communication between the tiles.

The synchronization support provided by the Compute Engine Control Block (CCB) removes the need for synchronization between tiles and allows data movement to be optimized between tiles off-line in the compiler.

In a conventional system the tiles in the compute engine send/receive data at different times, each tile is unaware of data sent by other tiles and currently transiting the network. In a constrained network this results in frequent conflicts as data contend for the same links to complete routes. The locations and timings of these conflicts are unpredictable because they depend on the parts of the program that each tile is currently executing. To address this, conventional networks must support large routers, buffers, and complete arbitration logic to prioritize and stall data packets. These conflicts can be analyzed in the compiler, and routes with conflicts can be dropped in favor of conflict-free routes. This allows an improved routing solution with less router and buffer complexity.

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

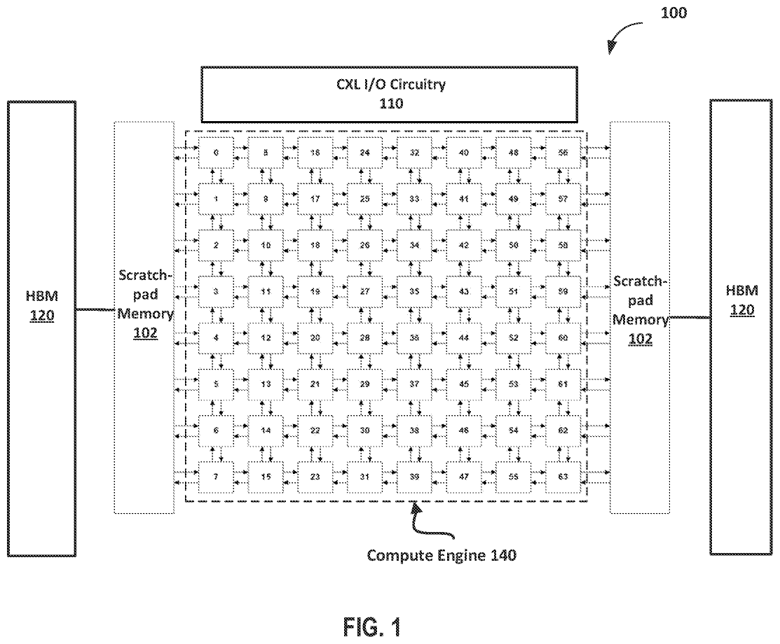

FIG. 1 illustrates an example system 100. In some examples, system 100 can be included in and/or operate within a compute platform. The compute platform, for example, could be located in a data center included in, for example, cloud computing infrastructure, examples are not limited to system 100 included in a compute platform located in a data center. As shown in FIG. 1, system 100 includes compute express link (CXL) input/output (I/O) circuitry 110, high bandwidth memory (HBM) 120, scratch pad memory 102 and tile array in a compute engine 140 (also referred to as a tile array).

In some examples, system 100 can be configured as a parallel processing device or accelerator to perform NTT/iNTT operations/computations for accelerating FHE workloads. For these examples, CXL I/O circuitry 110 can be configured to couple with one or more host central processing units (CPUs—not shown) to receive instructions and/or data via circuitry designed to operate in compliance with one or more CXL specifications published by the CXL Consortium to included, but not limited to, CXL Specification, Rev. 2.0, Ver. 1.0, published Oct. 26, 2020, or CXL Specification, Rev. 3.0, Ver. 1.0, published Aug. 1, 2022. Also, CXL I/O circuitry 110 can be configured to enable one or more host CPUs to obtain data associated with execution of accelerated FHE workloads by compute elements included in interconnected tiles of the compute engine 140. For example, data (for example, ciphertext or processed ciphertext) may be moved to or moved from HBM 120 and CXL I/O circuitry 110 can facilitate the data movement into or out of HBM 120 as part of execution of accelerated FHE workloads. Also, scratch pad memory 102 can be a type of memory (for example, register files) that can be proportionately allocated to tiles included in tile array in compute engine 140 to facilitate execution of the accelerated FHE workloads and to perform NTT/iNTT operations.

In some examples, as described in more detail below, tile array (array of tiles) in compute engine 140 can be arranged in an 8×8 tile configuration as shown in FIG. 1 that includes tiles 0 to 63. For these examples, each tile in the array of tiles can include, but is not limited to, 128 compute elements (not shown in FIG. 1). The 128 compute elements can be 128 separately reconfigurable butterfly circuits, that are configured to compute output terms associated with polynomial coefficients for NTT/iNTT operations/computations. As shown in FIG. 1, tiles 0 to 63 can be interconnected via point-to-point connections via a 2-dimensional (2D) mesh interconnect-based architecture. The 2D mesh enables communications between adjacent tiles using single-hop links. Tiles included in tile array in compute engine 140 can be augmented with router circuitry that can route data received via inputs or sent via outputs across all 4 directions. Each tile in the array of tiles includes a connection to one or more other tiles comprising a network.

Examples are not limited to use of CXL I/O circuitry such as CXL I/O circuitry 110 to facilitate receiving instructions and/or data or providing executed results associated with FHE workloads. Other types of I/O circuitry and/or additional circuitry to receive instructions and/or data or provide executed results are contemplated.

Examples are not limited to HBM such as HBM 120 for receiving data to be processed (memory to store the data to be processed) or to store information associated with instructions to execute an FHE workload or execution results of the FHE workload. Other types of volatile memory or non-volatile memory are contemplated for use in system 100. Other types of volatile memory can include, but are not limited to, Dynamic RAM (DRAM), DDR synchronous dynamic RAM (DDR SDRAM), GDDR, static random-access memory (SRAM), thyristor RAM (T-RAM) or zero-capacitor RAM (Z-RAM). Non-volatile types of memory can include byte or block addressable types of non-volatile memory such as, but not limited to, multi-threshold level NAND flash memory, NOR flash memory, single or multi-level phase change memory (PCM), resistive memory, nanowire memory, ferroelectric transistor random access memory (FeTRAM), anti-ferroelectric memory, resistive memory including a metal oxide base, an oxygen vacancy base and a conductive bridge random access memory (CB-RAM), a spintronic magnetic junction memory, a magnetic tunneling junction (MTJ) memory, a domain wall (DW) and spin orbit transfer (SOT) memory, a thyristor based memory, a magnetoresistive random access memory (MRAM) that incorporates memristor technology, spin transfer torque MRAM (STT-MRAM), or a combination of any of the above.

According to some examples, system 100 can be included in a system-on-a-chip (SoC). SoC is a term often used to describe a device or system having a compute elements and associated circuitry (e.g., I/O circuitry, butterfly circuits, power delivery circuitry, memory controller circuitry, memory circuitry, etc.) integrated monolithically into a single integrated circuit (“IC”) die, or chip. For example, a device, computing platform or computing system could have one or more compute elements (for example, butterfly circuits) and associated circuitry (for example, I/O circuitry, power delivery circuitry, memory controller circuitry, memory circuitry, etc.) arranged in a disaggregated collection of discrete dies, tiles and/or chiplets (e.g., one or more discrete compute die arranged adjacent to one or more other die such as memory die, I/O die, etc.). In such disaggregated devices and systems the various dies, tiles and/or chiplets could be physically and electrically coupled together by a package structure including, for example, various packaging substrates, interposers, interconnect bridges and the like. Also, these disaggregated devices can be referred to as a system-on-a-package (SoP).

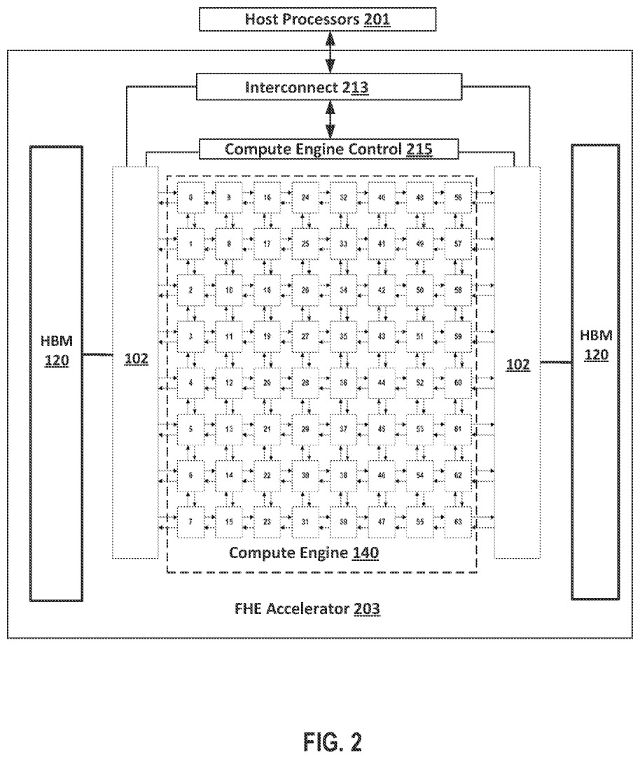

FIG. 2 illustrates an example of a fully homomorphic encryption accelerator 203. As shown, the FHE accelerator 203 couples to one or more host processors 201 such as one or more central processing unit (CPU) cores via one or more interconnects 213.

The one or more interconnects 213 coupled to scratch pad memory 102 which handles load/stores of data and provides data for execution by the compute engine 140 comprising a plurality of tiles 0 to 63. In some examples, the tiles 0 to 63 are coupled to scratch pad memory 102, the interconnect 213, and/or a compute engine control block 215.

The scratch pad memory 102 is coupled to high bandwidth memory (HBM) 120 which stores a larger amount of data. In some examples, the data is distributed across channels of HBM 120 and banks of scratch pad memory 102. In some examples, HBM 120 is external to the FHE accelerator 203. In some examples, some HBM 120 is external to the FHE accelerator 203 and some HBM 120 is internal to the FHE accelerator 203.

In some examples, a compute engine control block 215 dispatches instructions and handles synchronization of data from the HBM 120 and scratch pad memory 102 for the compute engine 140. In some examples, memory loads and stores from/to HBM 120 are tracked in the compute engine control block 215 and dispatched across the scratch pad memory 102 for coordinated data fetch. These loads and stores are handled locally in the scratch pad memory 102 and written into the scratch pad memory 102 and/or HBM 120. In some examples, the compute engine control block 215 includes an instruction decoder to decode the instructions detailed herein. In some examples, a decoder of a host processor 201 decodes the instructions to be executed by the compute engine 140.

In some examples, the basic organization of the FHE compute engine 140 is a wide and flexible array of functional units organized in a butterfly configuration. The array of butterfly units is tightly coupled with a register file capable of storing one or more of FHE operands (e.g., entire input and output ciphertexts), twiddle factor constants, relevant public key material, etc. In some examples, the FHE operands, twiddle factors, key information, etc. are stored as polynomial coefficients.

The FHE compute engine 140 performs polynomial multiplication, addition, modulo reduction, etc. Given aᵢ and bᵢ in [symbol] _{q}, two polynomials a(x) and b(x) over the ring can be expressed as

$$a ( x ) = {a}_{0} + {a}_{1} x + {a}_{2} {x}^{2} + ⋯ {a}_{n - 1} {x}^{n - 1}$$

$$b ( x ) = {b}_{0} + {b}_{1} x + {b}_{2} {x}^{2} + ⋯ {b}_{n - 1} {x}^{n - 1}$$

In some examples, an initial configuration of the array with respect to the register file allows full reuse of the register file while processing Ring-LWE polynomials with degree up to N=16,384 and log q=512-bit long coefficients; and partial reuse beyond such parameters, for which processing ciphertexts require data movement from and to the upper levels in the memory hierarchy.

In some examples, the FHE compute engine 140 is composed of 512-bit Large Arithmetic Word Size (LAWS) units organized as vectored butterfly data paths. The butterfly units (LAWS or not) are designed to natively support operations on operands in either their positional form or leveraging Chinese Remainder Theorem (CRT) representation. In some examples, a double-CRT representation is used. The first CRT layer uses the Residue Number System (RNS) to decompose a polynomial into a tuple of polynomials with smaller moduli. The second layer converts each of small polynomials into a vector of modulo integers via NTT. In the double-CRT representation, an arbitrary polynomial is identified with a matrix consisting of small integers, and this enables an efficient polynomial arithmetic by performing component-wise modulo operations. The RNS decomposition offers the dual promise of increased performance using Single Instruction/Multiple Data (SIMD) operations along with a quadratic reduction in area with decreasing operand widths.

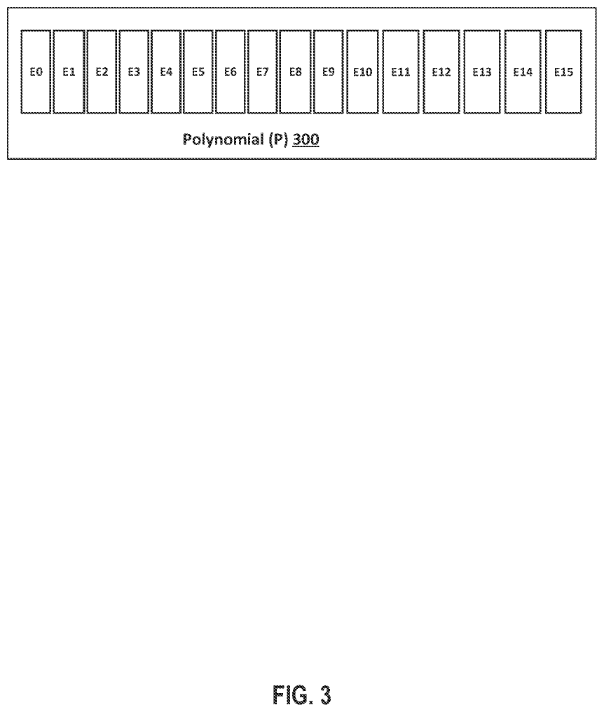

FIG. 3 is a block diagram of a polynomial 300 used by the FHE accelerator 203 to perform FHE computations. In the embodiment shown in FIG. 3, the polynomial 300 has 32K bytes and includes 16 elements E0, . . . E15, with each element having 2K bytes.

The scratch pad memory 102 to store coefficients to be used by the plurality of compute elements to perform polynomial operations on polynomials. The number of scratch pad memory units (scratch pad banks) SP0, . . . SP15 in scratch pad memory 102 corresponds to the number of elements in the polynomial 300. Each scratch pad memory unit (scratch pad bank) SP0, . . . SP15 stores 2K bytes. The 2K bytes are read from a respective scratch pad memory units (scratch pad banks) SP0, . . . SP15 as 4 512 byte blocks.

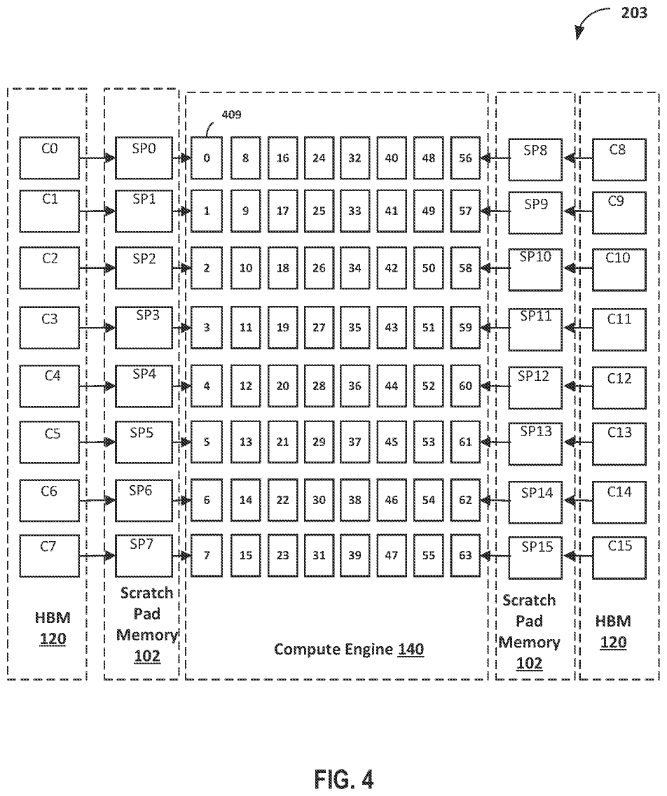

FIG. 4 is a block diagram illustrating distribution of the elements E0, . . . E15 of the polynomial 300 shown in FIG. 3 in the FHE accelerator 203 to execute instructions in lockstep across tiles 409 in the compute engine 140. FHE workloads require the manipulation of large data words. In order to maximize parallelism, the data words are organized with different elements of the polynomial 300 straddling different memory resources in the FHE accelerator 203. In an embodiment, the 32K Bytes of polynomial 300 are split into 16 2K elements E0, . . . E15 with each element E0, . . . E15 of the polynomial 300 stored in one of 16 channels C0, . . . C15 in the HBM 120. The polynomial 300 has a plurality of coefficients that are distributed across the array of tiles.

Each memory channel C0, . . . C15 in the HBM 120 is coupled with a respective scratch pad memory unit (scratch pad bank) SP0, . . . SP15 in scratch pad memory 102. Each scratch pad memory unit SP0, . . . SP15 is coupled with a respective group of the 64 tiles in the compute engine 140. In an embodiment, the group of the 64 tiles has four tiles 309 in a row of tiles in the compute engine. Each group of four tiles can load/store data from/to a respective scratch pad memory unit SP0, . . . SP15 in scratch pad memory 102 independently which maximizes parallelism and overall performance.

The compute engine control block 215 dispatches an mload instruction to move a block of data into the compute engine 140. In a compute engine with N channels of HBM 120, the block of data is handled per channel in the HBM 120. In an embodiment in which there are 16 memory channels in the HBM 120 and the block of data is 32 KB, the compute engine control block 215 dispatches the 32 KB memory read/write request across all 16 memory channels and each memory channel in the HBM 120 handles a 2 KB write/read transaction to/from HBM 120.

NTT (Number Theoretic Transform) operations are critical for FHE workloads and can account for 70-80% of the execution time. The NTT operations require global interaction between the 64 tiles 409 in the compute engine 140. The 64 tiles 409 in the compute engine 140 execute in lockstep, for example, when an NTT operation is executed on one tile 409, NTT operations are simultaneously executed on the other tiles 409. When the tiles 409 in the compute engine 140 operate in lockstep, the movement of data between the tiles 409 is planned in advance at compile time (when the workload is compiled), allowing static optimization (at compile time) and global optimization (compiler has knowledge of the whole program before the program is run), and ultimately better performance.

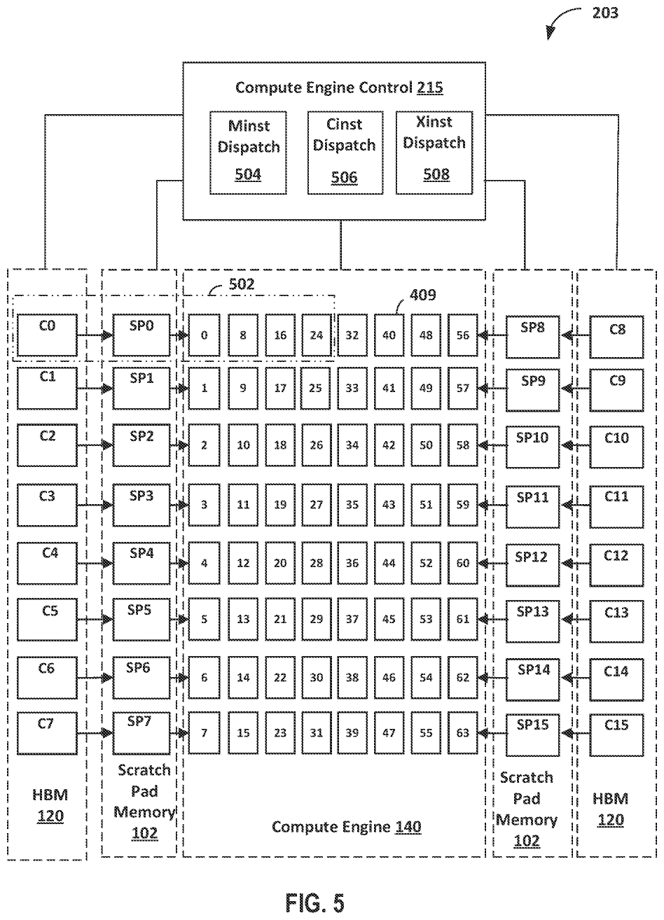

FIG. 5 is a block diagram illustrating dispatch of instructions by the compute engine control block 215 in the FHE accelerator. The compute engine control block 215 dispatches instructions and handles synchronization of data between the HBM 120, compute engine 140 and scratch pad memory 102. Data is distributed across HBM channels (C0-C15) and SPAD banks (SP0-SP15). In some examples, the compute engine control block 215 includes an instruction decoder to decode instructions. In some examples, a decoder of a host processor 201 decodes the instructions to be executed by the compute engine 140.

The compute engine control block 215 decomposes a load of a large data word into smaller load requests for each of the plurality of memory channels (HBM channels ((C0-C15)). The compute engine control block 215 to decompose a store of a large data word into smaller store requests for each of the plurality of memory channels (HBM channels ((C0-C15)).

The compute engine control block 215 dispatches memory instructions (Minst), scratch pad (SPAD) instructions (Cinst) and compute element instructions (Xinst). The compute engine control block 215 includes Minst dispatch 504 to dispatch memory instructions (Minst). Memory instructions include memory load (mload) and memory store (mstore) instructions.

A memory load (Mload) instruction moves data from HBM 120 to the scratch pad memory 102. Data read from HBM 120 is stored in a read fill buffer in scratch pad memory 102 prior to be written to the scratch pad memory 102. A memory store (Mstore) instruction moves data from the scratch pad memory 102 to the HBM 120. Data is stored in a write fill buffer in the scratch pad memory 102 prior to being written to the HBM 120. The Mload instructions and Mstore instructions distribute data across HBM channels (C0-C15) in HBM 120 and scratch pad memory banks (SP0-SP15) in scratch pad memory 102. The Mload instructions and the MStore instructions arc dispatched to banks (SP0-SP15) in scratch pad memory 102 and are tracked in the compute engine control block 215.

The compute engine control block 215 includes Cinst dispatch 506 to dispatch scratch pad memory instructions. Scratch pad memory instructions (Cinst) include scratch pad memory load (Cload) and scratch pad memory store (Cstore). Cloads and Cstores are dispatched across all banks (SP0-SP15) in scratch pad memory 102 for coordinated data fetch. A scratch pad memory load instruction (Cload) moves data from the scratch pad memory 102 to the compute engine control block 215. A scratch pad memory store instruction (Cstore) moves data from the compute engine control block 215 to the scratch pad memory 102.

The compute engine control block 215 includes Xinst dispatch 508 to dispatch compute element (Xinst) instructions. Compute element instructions (Xinst) include math and compute element instructions. Xinst dispatch 508 dispatches Xinsts as a bundle (block of 64 Xinsts) to the compute engine 140, with one Xinst dispatched to one of the 64 tiles in the compute engine 140.

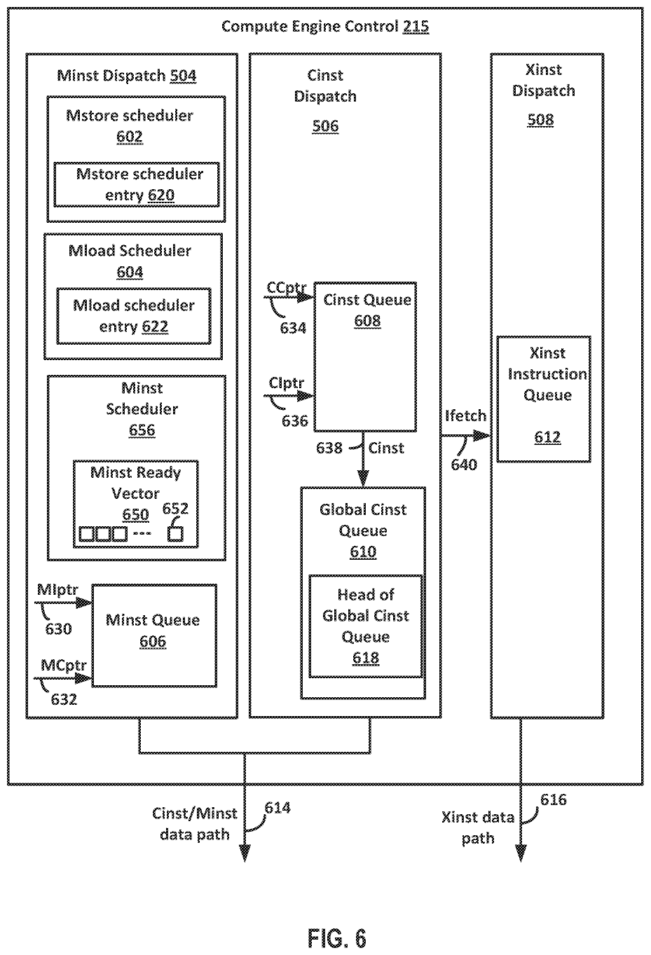

FIG. 6 is a block diagram illustrating the Minst dispatch 404, Cinst dispatch 406 and Xinst dispatch 508 in the compute engine control block 215.

Cinst dispatch 406 includes a Cinst Queue 608 and a global Cinst queue 610. Xinst dispatch 508 includes an Xinst Instruction queue 612.

Minst dispatch 404 includes an Mstore scheduler 602, an Mload scheduler 604, a Minst queue 606 and a Minst scheduler 656. The Mstore scheduler 602 stores an Mstore instruction in an Mstore scheduler entry 620. The Mload scheduler 604 stores a Mload instruction in an Mload scheduler entry 622. The Minst queue 606 stores Mload instructions, Mstore instructions and MsyncC instructions. The MsynC instruction stalls the Minst queue 606 until the Cinst Queue 610 has reached a particular point as determined by the CCptr.

Mfetch instructions include the Mload instruction, Mstore instruction and the MsyncC instruction. The Mfetch instructions include an address (Im_address) in HBM 120 and an address (Sp_address) in scratch pad memory 102. The Mload instruction loads the data from the HBM address in HBM 120 and writes it into the location specified by the Sp_address in scratch pad memory 102. The Mstore instruction reads data from the location specified by the Sp_address in scratch pad memory 102 and writes the data to the location in HBM 120 specified by the Im_address.

The Minst scheduler 656 includes a Minst ready vector 650 for each Minst instruction (Mload instruction and Mstore instruction) in the Minst queue 606. When a Minst (Mload, Mstore) instructions is issued from the Minst queue 606, the Minst is copied with the MIptr into the Minst queue 606 prior to being scheduled by the Mstore scheduler 602 or the Mload scheduler 604. The status of each Mload instruction to load 2 KB from 16 channels B0, . . . B15 in the HBM 120 to 16 banks SP0, . . . SP15 in scratch pad memory 102 are tracked independently because the latency of the HBM 120 can vary over time. To determine whether the Mload instruction to load 2 KB in 16 banks SP0, . . . SP15 in the scratchpad memory 102 has completed, the Minst ready vector 650 includes 16 bits, with 1-bit 652 corresponding to one 2 KB portion stored in one of 16 banks SP0, . . . SP15 in the scratch pad memory 102. All 16 bits set to ‘1’ indicate that the Minst is complete. The Mload instruction is complete when all 2 KB portions have been loaded in the 16 banks SP0, . . . SP15 in the scratchpad memory 102. The Minst ready vector 650 allows the compute engine control block 215 to maintain a global ready status for the completion of the Mload instruction. The status of each Mstore instruction to load 2 KB from 16 banks SP0, . . . SP15 in scratchpad memory 102 to 16 channels B0, . . . B15 in the HBM 120 are also tracked independently in an Minst ready vector 650 in the Minst queue 606.

Minst dispatch 404 uses two pointers (Memory Issue pointer (MIptr 630) and Memory Completion pointer (MCptr 632) to manage the Minst queue 606. The Minst queue 606 is a First In First Out (FIFO) queue. If all bits are set to ‘1’ in the oldest Minst ready vector 650 in the Minst queue 606, the MCptr 632 and MIptr 630 are incremented and a new Minst entry with all bits in the Minst ready vector 650 set to ‘0’ is added to the Minst queue 606.

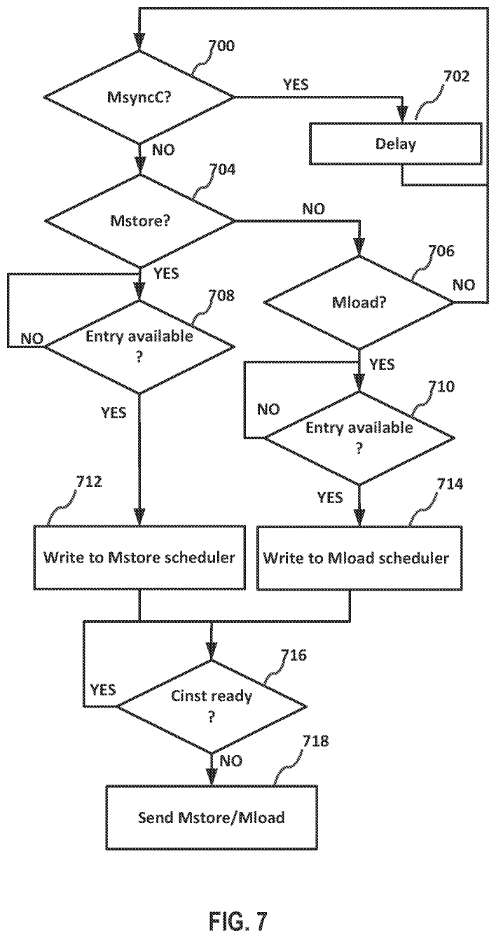

FIG. 7 is a flowgraph illustrating dispatch of a Minst on the Cinst/Minst data path 614 in the compute engine control block 215. In the embodiment discussed in conjunction with FIG. 7, a Cinst in the Cinst queue 608 is processed before a Minst in the Minst queue 606. In another embodiment, a Minst in the Minst queue 606 can be processed before a Cinst in the Cinst queue 608 is processed.

At block 700, if the next instruction in the Minst queue 606 is an MsyncC instruction, processing continues with block 702. If not, processing continues with block 704.

At block 702, the next instruction in the Minst queue 606 is an MsyncC instruction, the processing of entries on the Minst queue 606 is stalled for a delay time. The delay time is dependent on a value of the CCptr 634. Processing continues with block 700 to process the next instruction in the Minst queue 606.

At block 704, if the next instruction in the Minst queue is an Mstore instruction, processing continues with block 708. If not, processing continues with block 706.

At block 706, if the next instruction in the Minst queue is an Mload instruction, processing continues with block 710. If not, processing continues with block 700 to process the next instruction in the Minst queue 606.

At block 708, if there is an Mstore scheduler entry 620 available in the Mstore scheduler 602, processing continues with block 712.

At block 710, if there is an Mload scheduler entry 622 available in the Mload scheduler 604, processing continues with block 714.

At block 712, the Mstore instruction is written to the Mstore scheduler entry 620 in the Mstore scheduler 602. Processing continues with block 716.

At block 714, the Mload instruction is written to the Mload scheduler entry 622 in the Mload scheduler 604. Processing continues with block 716.

At block 716, if there is a Cinst ready in the Cinst queue 608, processing continues with block 716. If not, processing continues with block 718.

At block 718, the Minst (Mstore or Mload) is sent on the Cinst/Minst data path 614.

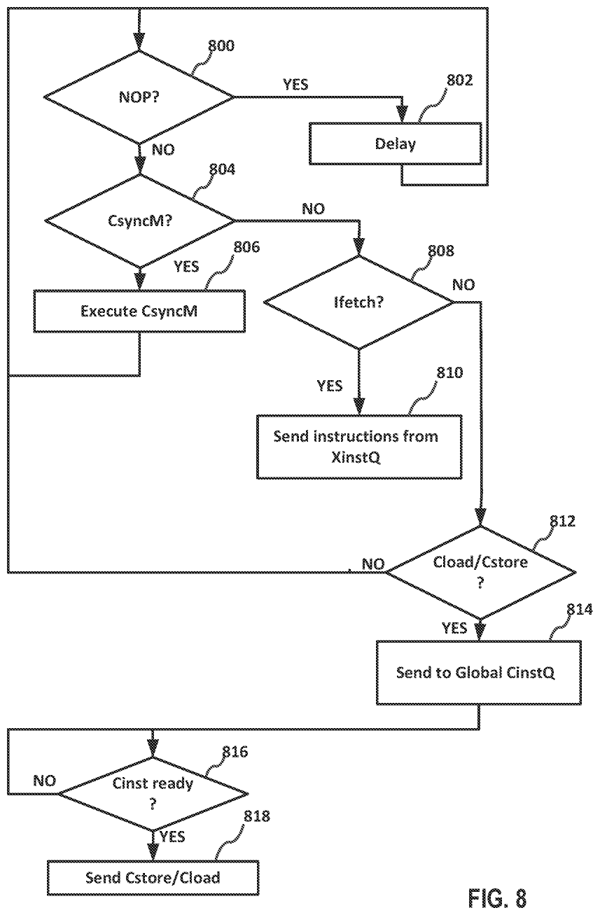

FIG. 8 is a flowgraph illustrating dispatch of Cinst on the Cinst/Minst data path 614 in the compute engine control block 215 and Xinst on the Xinst data path 616. In the embodiment discussed in conjunction with FIG. 8, a Cinst in the Cinst queue 608 is processed before a Minst in the Minst queue 606. In another embodiment, a Minst in the Minst queue 606 can be processed before a Cinst in the Cinst queue 608 is processed.

At block 800, if the next instruction in the Cinst queue 608 is an NOP (no operation) instruction, processing continues with block 802. If not, processing continues with block 804.

At block 802, the next instruction in the Cinst queue 608 is a NOP (No OPeration) instruction, to generate a delay in execution a NOP delay is executed. The NOP instruction includes a variable latency based on an immediate value in the instruction. The next Cinst instruction on the Cinst queue 608 is stalled for a period of time based on the variable latency in the NOP instruction. Processing continues with block 800 to process the next instruction in the Cinst queue 608.

At block 804, if the next instruction in the Cinst queue 608 is a CsyncM instruction, processing continues with block 806. If not, processing continues with block 808.

At block 806, the next instruction in the Cinst queue 608 is a CsyncM instruction. The CsyncM instruction is executed. The CsyncM instruction checks the current value of the MCptr 632. If the current value of the MCptr 632 is greater than the value of the MCptr in the CsyncM instruction, processing continues with block 800 to process the next instruction in the Cinst queue 608. If the next instruction in the Cinst queue 608 is not a CsyncM instruction, processing continues with block 808.

At block 808, if the next instruction in the Cinst queue 608 is an iFetch (refers to a bundle of instructions in the Xinst), the iFetch 640 is sent to the Xinst dispatch 508 to get instructions from the Xinst instruction queue 612, processing continues with block 810. If the next instruction in the Cinst queue 608 is not an iFetch, processing continues with block 812.

At block 810, Xinst dispatch 508 dispatches Xinsts as a bundle (block of 64 Xinsts), with one Xinst dispatched to one of the 64 tiles in the compute engine 140. The bundle of instructions from the Xinst instruction queue 612 are sent on the Xinst data path 616. The Xinst bundle is buffered in each row of tiles in the compute engine 140 to allow synchronized dispatch along the compute engine daisy chain data path. Processing continues with block 812.

At block 812, if the next instruction in the Cinst queue 608 is a Cload instruction or a Cstore instruction, processing continues with block 814. If not, processing continues with block 800.

At block 814, a Cinst 638 (the Cload instruction or the Cstore instruction) is sent to the global Cinst queue 610 where it is delayed for 16 cycles to match the 16 cycles for the Xinst, Processing continues with block 816

At block 816, if there is a Cinst ready in the Cinst queue 608, processing continues with block 818. If not, processing continues with block 816.

At block 818, the Cinst (Cstore or Cload) at the head of the global Cinst queue 618 is sent on the Cinst/Minst data path 614.

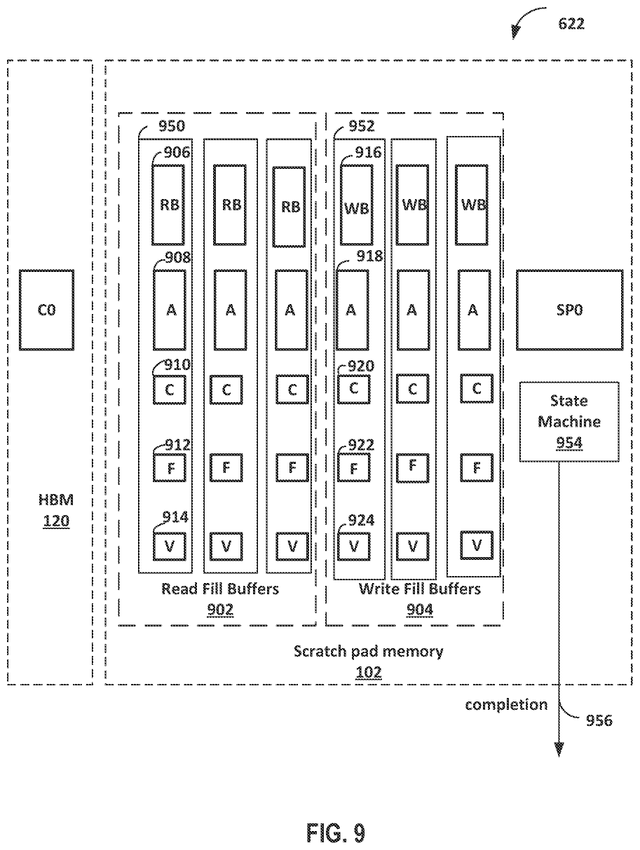

FIG. 9 is a block diagram illustrating use of memory instructions (Minst) to perform data transfer between the HBM 120 and the scratch pad memory 102. Memory instructions (Minst) are not buffered in the compute engine control block 215 to match Cinst/Xinst latencies. Memory instructions (Minst) dependencies are preserved through the use of sync instructions (CsyncM, MsyncC) in the compute engine control block 215. For example, if a Cinst is dependent on a Minst, the Cinst is preceded by a CsyncM instruction that includes a pointer to the Minst so that the Minst is completed prior to executing the Cinst. The sync instructions ((CsyncM, MsyncC) are tracked in the compute engine control block 215 and sync instruction stalls occur in the compute engine control block 215.

The scratch pad memory 102 includes read fill buffers 902, write fill buffers 904 and a state machine 954. The read fill buffers 902 are used to store data read from a channel (C0) in HBM 120 to be written to a scratch pad memory bank (SP0) in scratch pad memory 102 for an Mload instruction. The write fill buffers 904 are used to store data read from a scratch pad memory bank (SP0) in scratch pad memory 102 to be written to a channel (C0) in HBM 120 for an Mstore instruction.

In the embodiment shown, Read fill buffers 902 has three read fill buffer entries 950. Read data buffers (RB 906) and Write fill buffers 904 has three write fill buffer entries 952. Each read fill buffer entry 950 has a read data buffer (RB 906) to store data read from a channel (C0) in HBM 120. Each write buffer fill entry 952 has a write data buffer (WB 916) to store data to be written to a channel (C0) in HBM 120. In an embodiment, each read data buffer (RB 906) is a 2K buffer and each write data buffer (WB 916) is a 2K buffer. The three read fill buffer entries 950 and three write fill buffer entries 952 allow 3 Mload instructions and 3 Mstore instructions to be outstanding at a time.

Each read fill buffer entry 950 includes address (A 908) to store a scratchpad memory address and a HBM address, a complete bit (C 910), a valid bit (V 914) and full bits register (F 912). The complete bit (C 910) is set to ‘1’ when the read data buffer (RB 906) is full. The valid bit (V 914) is set to ‘1’ when the data in the RB 906 has been written to the scratch pad memory bank (SP0) for the Mload instruction. The full bits register (F 912) has 32 bits, each bit to track a 64 bit chunk of the 2K data written to the write data buffer (WB 916) or the read data buffer (RB 906).

An Mload store instruction received by the state machine 954 in the scratch pad memory 102 from Minst Dispatch 404 on the Cinst/Minst data path 614 includes a scratchpad memory address and a HBM address. A read fill buffer entry 950 with valid bit (V 914) set to ‘0’ (an invalid read fill buffer entry 950) is selected from the read fill buffers 902. The HBM address is sent to the HBM 120 to read data from the HBM channel (C0) and is stored in the address (A 908) in the read fill buffer entry 950. The scratch pad memory address is also stored in the address (A 908) in the read fill buffer entry 950. The valid bit (V 914) is set to ‘1’ and all bits in the full bits register (F 912) are set to ‘0’.

The 2K block of data is read from the channel (C0) in the HBM 120 in 64 byte (B) chunks. As each 64B chunk is received from the HBM 120, it stored in the read data buffer (RB 906) in the read fill buffer entry 950 until the 2 KB block of data has been received. The full bits in full bits register (F 912) are used to track each received 64B chunk, with one of the 32 full bits in full bits register (F 912) set to ‘1’ each time a 64B chunk is stored in the read data buffer (RB 906). After all 32 full bits are set to ‘1’ in the full bits register (F 912), the complete bit (C 910) is set to ‘l’ and the read buffer entry 950 arbitrates for a write port into the scratch pad memory 102.

The 2K block of data is written to the scratch pad memory in 512B chunks. As each 512B chunk is written to the scratch pad memory bank (SP0) in scratch pad memory 102, the full bits in the full bits register (F 912) corresponding to the 512B chunk are cleared (set to ‘0’). When the 2K block of data has been written to the scratch pad memory bank (SP0), all 32 bits of the full bits register (F 912) are set to ‘0’, a completion signal 956 is sent to the compute engine control block 215 and the valid bit (V 914) and complete bit (C 910) in the read fill buffer entry 950 are cleared (set to ‘0’.

An Mstore instruction received by the scratch pad memory 102 from Minst Dispatch 404 on the Cinst/Minst data path 614 includes a scratchpad memory address and a HBM address. A write fill buffer entry 952 with valid bit (V 924) set to ‘0’ (an invalid write fill buffer entry 952) is selected from the write fill buffers 904. The HBM address is stored in the address (A 918) in the write fill buffer entry 952. The scratch pad memory address is also stored in the address (A 918) in the write fill buffer entry 952. The valid bit (V 924) is set to ‘1’ and all bits in the full bits register (F 922) are set to ‘0’.

The 2K block of data is read from the scratch pad memory 102 in 512B chunks. As each 512B chunk is received from the scratch pad memory 102, it stored in the write data buffer (WB 916) in the write fill buffer entry 952 until the 2 KB block of data has been received. The full bits in the full bits register (F 922) are used to track each received 512B chunk, with the respective full bit in the full bits register (F 922) corresponding to the 512B chunk set to ‘1’ each time a 512B chunk is stored in the write data buffer (WB 916). After all 32 full bits are set to ‘1’ in the full bits register (F 922), the complete bit (C 920) is set to ‘1’.

The 2K block of data is written to channel (C0) in the HBM 120 in 64 byte (B) chunks. As each 64B chunk is written to channel (C0) in the HBM 120, the full bits in the full bits register (F 922) corresponding to the 64B chunk are cleared (set to ‘0’). When the 2K block of data has been written to channel (C0) in the HBM 120), all 32 bits of the full bits register (F 922) are set to ‘0’, a completion signal 956 is sent to the compute engine control block 215 and the valid bit (V 924) and complete bit (C 920) in the write fill buffer entry 952 are cleared (set to ‘0’).

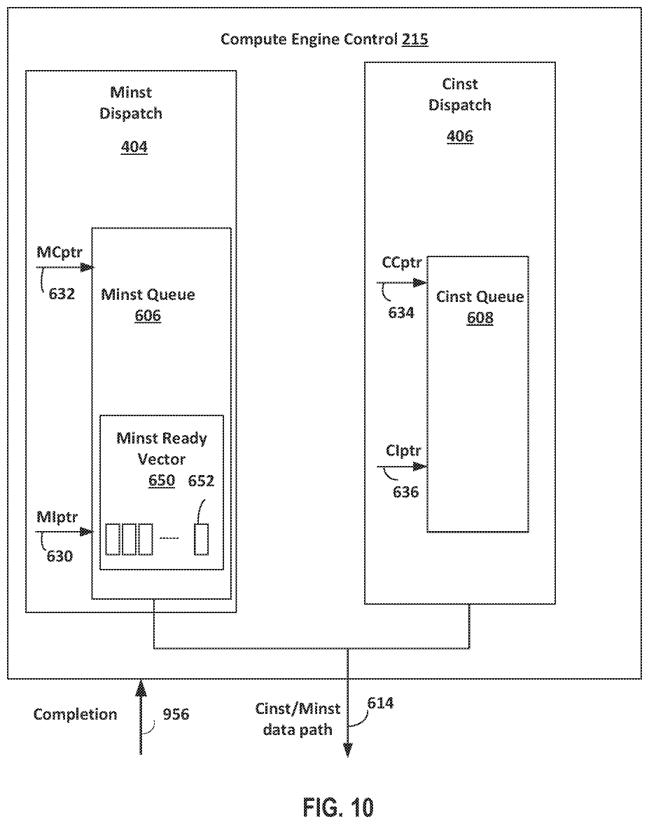

FIG. 10 is a block diagram of the compute engine control block 215 illustrating pointers used for synchronization support to manage instruction dispatch across all of the Compute Engine Control Block tiles and to ensure the compute engine tiles are operating in lockstep.

Minst dispatch 404 uses two pointers (Memory Issue pointer (MIptr 630) and Memory Completion pointer (MCptr 632)). The MIptr 630 tracks the last instruction issued from the minst queue 606. The MCptr 632 tracks the last instruction completed in the minst queue 606.

Cinst dispatch 406 uses two pointers (scratch pad memory Issue pointer (CIptr 636) and scratch pad memory Completion pointer (MCptr 632)). The Clptr 636 tracks the last instruction issued from the cinst queue 608. The CCptr 634 tracks the last instruction completed in the cinst queue 608.

Before an mload instruction can be issued from the minst queue 606, an mload scheduler entry 622 in the mload scheduler 604 must be available to allocate an minst ready vector 650 to track the 2 KB sub-blocks in the 32 KB data word. If an mload scheduler entry 622 is available, the mload instruction is issued and the MIptr 630 is incremented, if not the mload scheduler 604 waits for an mload scheduler entry 622 to be available.

Before an mstore instruction can be issued from the minst queue 606, an mstore scheduler entry 620 in the mstore scheduler 602 must be available to allocate an minst ready vector 650 to track the 2 KB sub-blocks in the 32 KB data word. If an mstore scheduler entry 620 is available, the mstore instruction is issued and the MIptr 630 is incremented, if not the mstore scheduler 602 waits for an mstore scheduler entry 620 to be available.

The MCptr 632 points to the last completed Minst, if all issued Minst have completed, the MCptr 632 is the same as the MIptr 630. There are Minsts currently outstanding in the schedulers (mstore scheduler 602, mload scheduler 604), if MCptr 632 is less than MIptr 630. As Minsts are issued and allocated in the mload scheduler 604 and/or mstore scheduler 602, some of the previously allocated mload scheduler entries 622 and mstore scheduler entries 620 will have been completed (that is, each 1-bit 652 in the Minst ready vector 650 is set to ‘1’). After a Minst has completed, the MIptr 630 is compared to the MCptr 632, if the MIptr 630 and the MCptr 632 are equal (this indicates this is the oldest issued, incomplete Minst) the MCptr 632 is incremented and the Minst can be deallocated from the scheduler (mstore scheduler 602, mload scheduler 604), the Minst has been completed. The MsyncC instruction causes the Minst Queue 606 to stall for a delay time until the Cinst Queue 608 has reached a particular point as determined by the CCptr 634. The delay time is dependent on the current state of the cinst queue 608.

In contrast to Minsts, Cinsts do not require a scheduler or a ready vector because all latencies are fixed, correct scheduling of Cinsts and Xinsts only requires that fixed delays be added to Cinsts and Xinsts to align the execution of the Cinsts and Xinsts. The CsyncM checks Cinst dependencies on Minsts. If a Cinst depends on an Minst, the Cinst is preceded by a CsyncM instruction that points to a Minst to force the Minst to complete before the Cinst. The CsyncM instruction checks the current MCptr 632 (Minst completion pointer) and allows the CIptr 636 to dispatch additional Cinsts when the MCptr 632 has passed the point specified by the CsyncM instruction.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

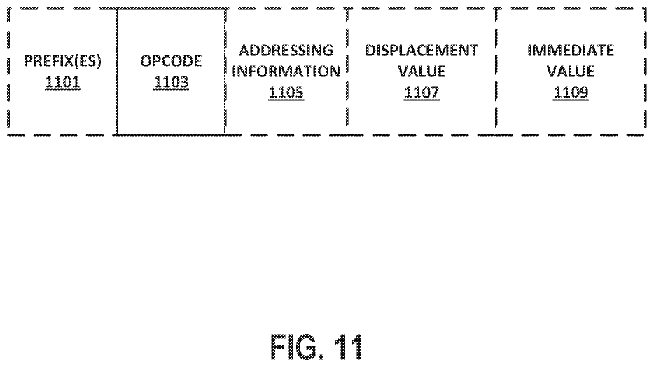

FIG. 11 illustrates examples of an instruction format. As illustrated, an instruction may include multiple components including, but not limited to, one or more fields for: one or more prefixes 1101, an opcode 1103, addressing information 1105 (e.g., register identifiers, memory addressing information, etc.), a displacement value 1107, and/or an immediate value 1109. Note that some instructions utilize some or all the fields of the format whereas others may only use the field for the opcode 1103. In some examples, the order illustrated is the order in which these fields are to be encoded, however, it should be appreciated that in other examples these fields may be encoded in a different order, combined, etc.

The prefix(es) field(s) 1101, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1103 is used to at least partially define the operation to be performed upon a decoding of the instruction. In some examples, a primary opcode encoded in the opcode field 1103 is one, two, or three bytes in length. In other examples, a primary opcode can be a different length. An additional 3-bit opcode field is sometimes encoded in another field.

The addressing information field 1705 is used to address one or more operands of the instruction, such as a location in memory or one or more registers.

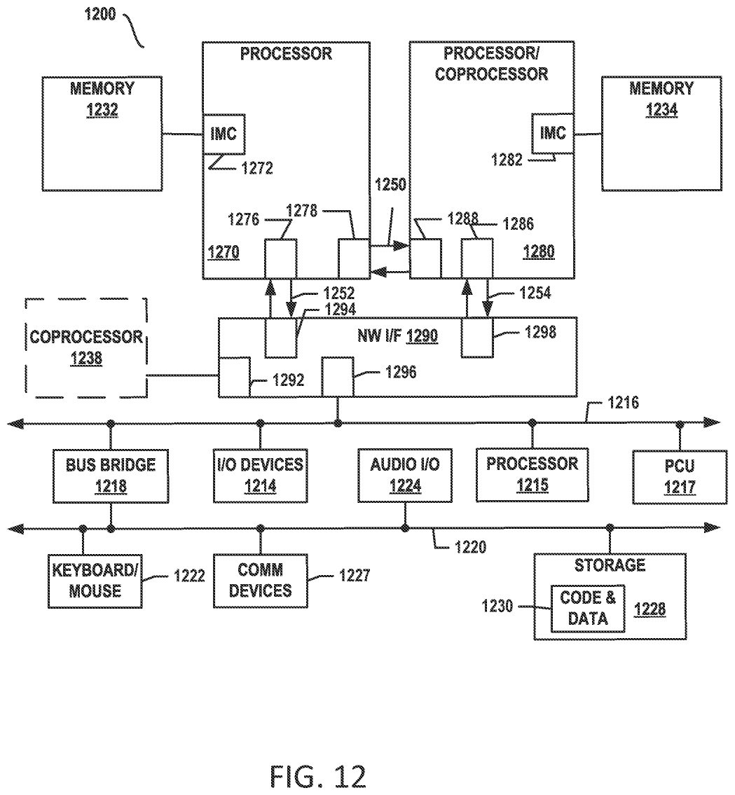

FIG. 12 illustrates an example computing system. Multiprocessor system 1200 is an interfaced system and includes a plurality of processors or cores including a first processor 1270 and a second processor 1280 coupled via an interface 1250 such as a point-to-point (P-P) interconnect, a fabric, and/or bus. In some examples, the first processor 1270 and the second processor 1280 are homogeneous. In some examples, first processor 1270 and the second processor 1280 are heterogenous. Though the example multiprocessor system 1200 is shown to have two processors, the system may have three or more processors, or may be a single processor system. In some examples, the computing system is a system on a chip (SoC).

Processors 1270 and 1280 are shown including integrated memory controller (IMC) circuitry 1272 and 1282, respectively. Processor 1270 also includes interface circuits 1276 and 1278; similarly, second processor 1280 includes interface circuits 1286 and 1288. Processors 1270, 1280 may exchange information via the interface 1250 using interface circuits 1278, 1288. IMCs 1272 and 1282 couple the processors 1270, 1280 to respective memories, namely a memory 1232 and a memory 1234, which may be portions of main memory (system memory) locally attached to the respective processors. The memory 1232 and memory 1234 to store instructions and data.

Processors 1270, 1280 may each exchange information with a network interface (NW I/F) 1290 via individual interfaces 1252, 1254 using interface circuits 1276, 1294, 1286, 1298. The network interface 1290 (e.g., one or more of an interconnect, bus, and/or fabric, and in some examples is a chipset) may optionally exchange information with a co-processor 1238 via an interface circuit 1292. In some examples, the co-processor 1238 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1270, 1280 or outside of both processors, yet connected with the processors via an interface such as a point to point (P-P) interconnect, such that either or both processors' local cache information may be stored in the shared cache if a processor is placed into a low power mode.

Network interface 1290 may be coupled to a first interface 1216 via interface circuit 1296. In some examples, first interface 1216 may be an interface such as a Peripheral Component Interconnect (PCI) interconnect, a PCI Express interconnect or another I/O interconnect. In some examples, first interface 1216 is coupled to a power control unit (PCU) 1217, which may include circuitry, software, and/or firmware to perform power management operations with regard to the processors 1270, 1280 and/or co-processor 1238. PCU 1217 provides control information to a voltage regulator (not shown) to cause the voltage regulator to generate the appropriate regulated voltage. PCU 1217 also provides control information to control the operating voltage generated. In various examples, PCU 1217 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1217 is illustrated as being present as logic separate from the processor 1270 and/or processor 1280. In other cases, PCU 1217 may execute on a given one or more of cores (not shown) of processor 1270 or 1280. In some cases, PCU 1217 may be implemented as a microcontroller (dedicated or general-purpose) or other control logic configured to execute its own dedicated power management code, sometimes referred to as P-code. In yet other examples, power management operations to be performed by PCU 1217 may be implemented externally to a processor, such as by way of a separate power management integrated circuit (PMIC) or another component external to the processor. In yet other examples, power management operations to be performed by PCU 1217 may be implemented within BIOS or other system software.

Various I/O devices 1214 may be coupled to first interface 1216, along with a bus bridge 1218 which couples first interface 1216 to a second interface 1220. In some examples, one or more additional processor(s) 1215, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1216. In some examples, second interface 1220 may be a low pin count (LPC) interface. Various devices may be coupled to second interface 1220 including, for example, a keyboard and/or mouse 1222, communication devices 1227 and storage circuitry 1228. Storage circuitry 1228 may be one or more non-transitory machine-readable storage media as described below, such as a disk drive or other mass storage device which may include instructions/code and data 1230 and may implement the storage ‘ISAB03 in some examples. Further, an audio I/O 1224 may be coupled to second interface 1220. Note that other architectures than the point-to-point architecture described above are possible. For example, instead of the point-to-point architecture, a system such as multiprocessor system 1200 may implement a multi-drop interface or other such architecture.

### Example Core Architectures, Processors, and Computer Architectures.

Processor cores (“cores”) may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality.

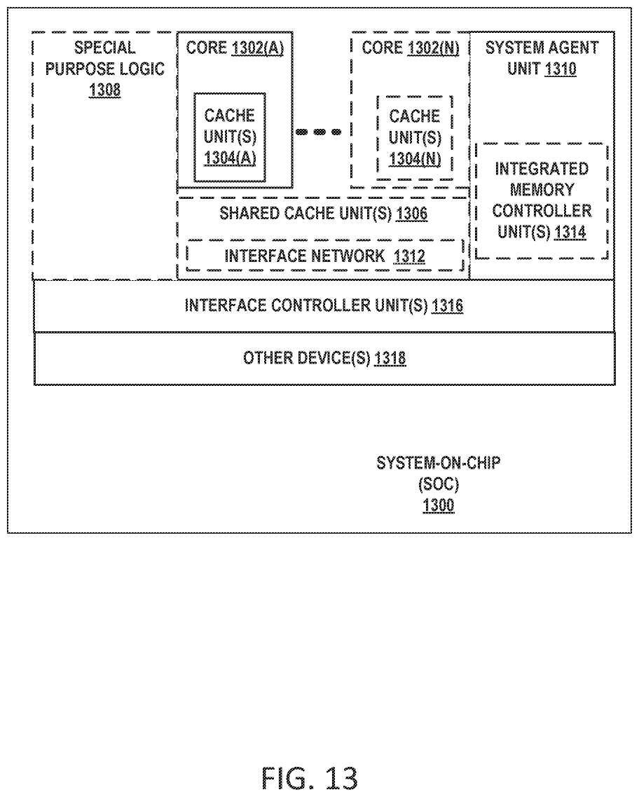

FIG. 13 illustrates a block diagram of an example SoC 1300 that may have one or more processor cores and an integrated memory controller. The SoC 1300 includes different components (hardware elements), also called “blocks” or subsystems.

The solid lined boxes illustrate an SoC 1300 with a single processor core 1302(A), system agent unit circuitry 1310, and a set of one or more interface controller unit(s) circuitry 1316, while the optional addition of the dashed lined boxes illustrates an alternative SoC 1300 with multiple cores 1302(A)-(N), a set of one or more integrated memory controller unit(s) circuitry 1314 in the system agent unit circuitry 1310, and special purpose logic 1308, as well as a set of one or more interface controller units circuitry 1316. Note that the SoC 1300 may be one of the processors 1270 or 1280, or co-processor 1238 or 1215 of FIG. 12.

Thus, different implementations of the SoC 1300 may include: 1) a CPU with the special purpose logic 1308 being integrated graphics and/or scientific (throughput) logic (which may include one or more cores, not shown), and the cores 1302(A)-(N) being one or more general purpose cores (e.g., general purpose in-order cores, general purpose out-of-order cores, or a combination of the two); 2) a coprocessor with the cores 1302(A)-(N) being a large number of special purpose cores intended primarily for graphics and/or scientific (throughput); and 3) a coprocessor with the cores 1302(A)-(N) being a large number of general purpose in-order cores. Thus, the SoC 1300 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The SoC 1300 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1304(A)-(N) within the cores 1302(A)-(N), a set of one or more shared cache unit(s) circuitry 1306, and external memory (not shown) coupled to the set of integrated memory controller unit(s) circuitry 1314. The set of one or more shared cache unit(s) circuitry 1306 may include one or more mid-level caches, such as level 2 (L2), level 3 (L3), level 4 (L4), or other levels of cache, such as a last level cache (LLC), and/or combinations thereof. While in some examples interface network circuitry 1312 (e.g., a ring interconnect) interfaces the special purpose logic 1308 (e.g., integrated graphics logic), the set of shared cache unit(s) circuitry 1306, and the system agent unit circuitry 1310, alternative examples use any number of well-known techniques for interfacing such units. In some examples, coherency is maintained between one or more of the shared cache unit(s) circuitry 1306 and cores 1302(A)-(N). In some examples, interface controller units circuitry 1316 couple the cores 1302 to one or more other devices 1318 such as one or more I/O devices, storage, one or more communication devices (e.g., wireless networking, wired networking, etc.), etc.

In some examples, one or more of the cores 1302(A)-(N) are capable of multi-threading. The system agent unit circuitry 1310 includes those components coordinating and operating cores 1302(A)-(N). The system agent unit circuitry 1310 may include, for example, power control unit (PCU) circuitry and/or display unit circuitry (not shown). The PCU may be or may include logic and components needed for regulating the power state of the cores 1302(A)-(N) and/or the special purpose logic 1308 (e.g., integrated graphics logic). The display unit circuitry is for driving one or more externally connected displays.

The cores 1302(A)-(N) may be homogenous in terms of instruction set architecture (ISA). Alternatively, the cores 1302(A)-(N) may be heterogeneous in terms of ISA; that is, a subset of the cores 1302(A)-(N) may be capable of executing an ISA, while other cores may be capable of executing only a subset of that ISA or another ISA.

### Example Core Architectures—In-Order and Out-of-Order Core Block Diagram.

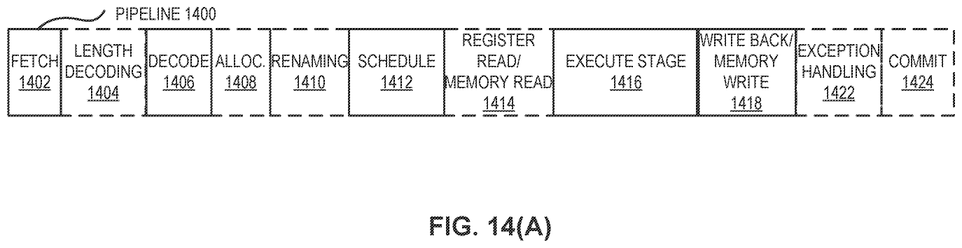

FIG. 14(A) is a block diagram illustrating both an example in-order pipeline and an example register renaming, out-of-order issue/execution pipeline according to examples. FIG. 14(B) is a block diagram illustrating both an example in-order architecture core and an example register renaming, out-of-order issue/execution architecture core to be included in a processor according to examples. The solid lined boxes in FIGS. 14(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 14(A), a processor pipeline 1400 includes a fetch stage 1402, an optional length decoding stage 1404, a decode stage 1406, an optional allocation (Alloc) stage 1408, an optional renaming stage 1410, a schedule (also known as a dispatch or issue) stage 1412, an optional register read/memory read stage 1414, an execute stage 1416, a write back/memory write stage 1418, an optional exception handling stage 1422, and an optional commit stage 1424. One or more operations can be performed in each of these processor pipeline stages. For example, during the fetch stage 1402, one or more instructions are fetched from instruction memory, and during the decode stage 1406, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1406 and the register read/memory read stage 1414 may be combined into one pipeline stage. In one example, during the execute stage 1416, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 14(B) may implement the pipeline 1400 as follows: 1) the instruction fetch circuitry 1438 performs the fetch and length decoding stages 1402 and 1404; 2) the decode circuitry 1440 performs the decode stage 1406; 3) the rename/allocator unit circuitry 1452 performs the allocation stage 1408 and renaming stage 1410; 4) the scheduler(s) circuitry 1456 performs the schedule stage 1412; 5) the physical register file(s) circuitry 1458 and the memory unit circuitry 1470 perform the register read/memory read stage 1414; the execution cluster(s) 1460 perform the execute stage 1416; 6) the memory unit circuitry 1470 and the physical register file(s) circuitry 1458 perform the write back/memory write stage 1418; 7) various circuitry may be involved in the exception handling stage 1422; and 8) the retirement unit circuitry 1454 and the physical register file(s) circuitry 1458 perform the commit stage 1424.

FIG. 14(B) shows a processor core 1490 including front-end unit circuitry 1430 coupled to execution engine unit circuitry 1450, and both are coupled to memory unit circuitry 1470. The core 1490 may be a reduced instruction set architecture computing (RISC) core, a complex instruction set architecture computing (CISC) core, a very long instruction word (VLIW) core, or a hybrid or alternative core type. As yet another option, the core 1490 may be a special-purpose core, such as, for example, a network or communication core, compression engine, coprocessor core, general purpose computing graphics processing unit (GPGPU) core, graphics core, or the like.

The front-end unit circuitry 1430 may include branch prediction circuitry 1432 coupled to instruction cache circuitry 1434, which is coupled to an instruction translation lookaside buffer (TLB) 1436, which is coupled to instruction fetch circuitry 1438, which is coupled to decode circuitry 1440. In one example, the instruction cache circuitry 1434 is included in the memory unit circuitry 1470 rather than the front-end circuitry 1430. The decode circuitry 1440 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1440 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1440 may be implemented using various different mechanisms. Examples of suitable mechanisms include, but are not limited to, look-up tables, hardware implementations, programmable logic arrays (PLAs), microcode read only memories (ROMs), etc. In one example, the core 1490 includes a microcode ROM (not shown) or other medium that stores microcode for certain macroinstructions (e.g., in decode circuitry 1440 or otherwise within the front-end circuitry 1430). In one example, the decode circuitry 1440 includes a micro-operation (micro-op) or operation cache (not shown) to hold/cache decoded operations, micro-tags, or micro-operations generated during the decode or other stages of the processor pipeline 1400. The decode circuitry 1440 may be coupled to rename/allocator unit circuitry 1452 in the execution engine circuitry 1450.

The execution engine circuitry 1450 includes the rename/allocator unit circuitry 1452 coupled to retirement unit circuitry 1454 and a set of one or more scheduler(s) circuitry 1456. The scheduler(s) circuitry 1456 represents any number of different schedulers, including reservations stations, central instruction window, etc. In some examples, the scheduler(s) circuitry 1456 can include arithmetic logic unit (ALU) scheduler/scheduling circuitry, ALU queues, address generation unit (AGU) scheduler/scheduling circuitry, AGU queues, etc. The scheduler(s) circuitry 1456 is coupled to the physical register file(s) circuitry 1458. Each of the physical register file(s) circuitry 1458 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1458 includes vector registers unit circuitry, writemask registers unit circuitry, and scalar register unit circuitry. These register units may provide architectural vector registers, vector mask registers, general-purpose registers, etc. The physical register file(s) circuitry 1458 is coupled to the retirement unit circuitry 1454 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1454 and the physical register file(s) circuitry 1458 are coupled to the execution cluster(s) 1460. The execution cluster(s) 1460 includes a set of one or more execution unit(s) circuitry 1462 and a set of one or more memory access circuitry 1464. The execution unit(s) circuitry 1462 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1456, physical register file(s) circuitry 1458, and execution cluster(s) 1460 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1464). It should also be understood that where separate pipelines are used, one or more of these pipelines may be out-of-order issue/execution and the rest in-order.

In some examples, the execution engine unit circuitry 1450 may perform load store unit (LSU) address/data pipelining to an Advanced Microcontroller Bus (AMB) interface (not shown), and address phase and writeback, data phase load, store, and branches.

The set of memory access circuitry 1464 is coupled to the memory unit circuitry 1470, which includes data TLB circuitry 1472 coupled to data cache circuitry 1474 coupled to level 2 (L2) cache circuitry 1476. In one example, the memory access circuitry 1464 may include load unit circuitry, store address unit circuitry, and store data unit circuitry, each of which is coupled to the data TLB circuitry 1472 in the memory unit circuitry 1470. The instruction cache circuitry 1434 is further coupled to the level 2 (L2) cache circuitry 1476 in the memory unit circuitry 1470. In one example, the instruction cache 1434 and the data cache 1474 are combined into a single instruction and data cache (not shown) in L2 cache circuitry 1476, level 3 (L3) cache circuitry (not shown), and/or main memory. The L2 cache circuitry 1476 is coupled to one or more other levels of cache and eventually to a main memory.

The core 1490 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1490 includes logic to support a packed data instruction set architecture extension (e.g., AVX1, AVX2), thereby allowing the operations used by many multimedia applications to be performed using packed data.

### Example Execution Unit(s) Circuitry.

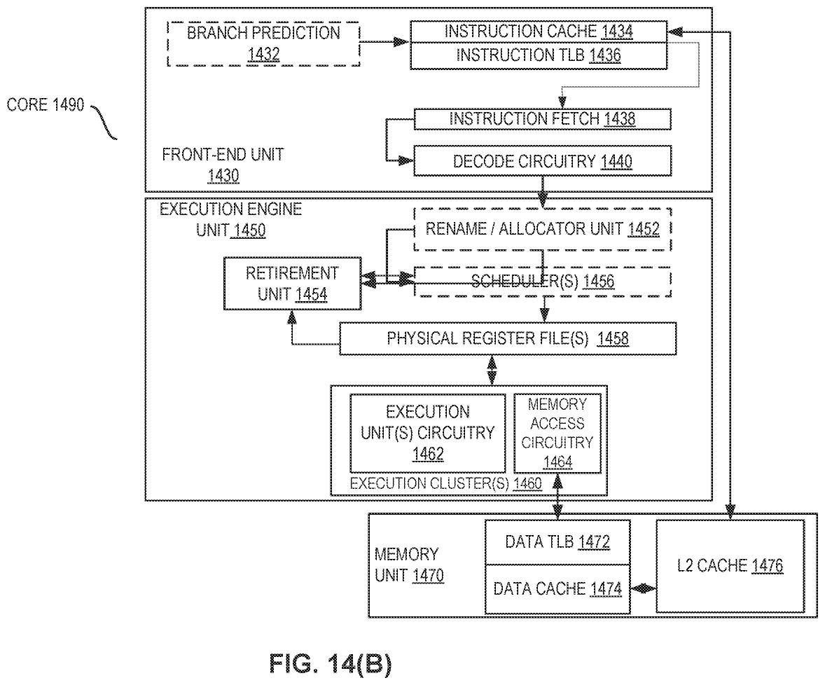

FIG. 15 illustrates examples of execution unit(s) circuitry, such as execution unit(s) circuitry 1462 of FIG. 14(B). As illustrated, execution unit(s) circuitry 1462 may include one or more ALU circuits 1501, optional vector/single instruction multiple data (SIMD) circuits 1503, load/store circuits 1505, branch/jump circuits 1507, and/or Floating-point unit (FPU) circuits 1509. ALU circuits 1501 perform integer arithmetic and/or Boolean operations. Vector/SIMD circuits 1503 perform vector/SIMD operations on packed data (such as SIMD/vector registers). Load/store circuits 1505 execute load and store instructions to load data from memory into registers or store from registers to memory. Load/store circuits 1505 may also generate addresses. Branch/jump circuits 1507 cause a branch or jump to a memory address depending on the instruction. FPU circuits 1509 perform floating-point arithmetic. The width of the execution unit(s) circuitry 1462 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

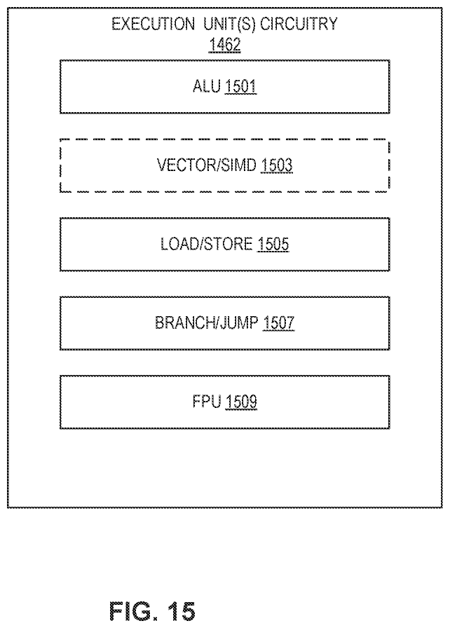

FIG. 16 is a block diagram of a register architecture 1600 according to some examples. As illustrated, the register architecture 1600 includes vector/SIMD registers 1610 that vary from 128-bit to 1,024 bits width. In some examples, the vector/SIMD registers 1610 are physically 512-bits and, depending upon the mapping, only some of the lower bits are used. For example, in some examples, the vector/SIMD registers 1610 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1600 includes writemask/predicate registers 1615. For example, in some examples, there are 8 writemask/predicate registers (sometimes called k0 through k7) that are each 16-bit, 32-bit, 64-bit, or 128-bit in size. Writemask/predicate registers 1615 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1615 corresponds to a data element position of the destination. In other examples, the writemask/predicate registers 1615 are scalable and consists of a set number of enable bits for a given vector element (e.g., 8 enable bits per 64-bit vector element).

The register architecture 1600 includes a plurality of general-purpose registers 1625. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1600 includes scalar floating-point (FP) register file 1645 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1640 (e.g., EFLAGS, RFLAGS, etc.) store status and control information for arithmetic, compare, and system operations. For example, the one or more flag registers 1640 may store condition code information such as carry, parity, auxiliary carry, zero, sign, and overflow. In some examples, the one or more flag registers 1640 are called program status and control registers.

Segment registers 1620 contain segment points for use in accessing memory. In some examples, these registers are referenced by the names CS, DS, SS, ES, FS, and GS.

Machine specific registers (MSRs) 1635 control and report on processor performance. Most MSRs 1635 handle system-related functions and are not accessible to an application program. Machine check registers 1660 consist of control, status, and error reporting MSRs that are used to detect and report on hardware errors.

One or more instruction pointer register(s) 1630 store an instruction pointer value. Control register(s) 1655 (e.g., CR0-CR4) determine the operating mode of a processor (e.g., processor 1270, 1280, 1238, 1215, and/or 1300) and the characteristics of a currently executing task. Debug registers 1650 control and allow for the monitoring of a processor or core's debugging operations.

Memory (mem) management registers 1665 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1600 may, for example, be used in register file/memory ‘ISAB08, or physical register file(s) circuitry 14 58.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

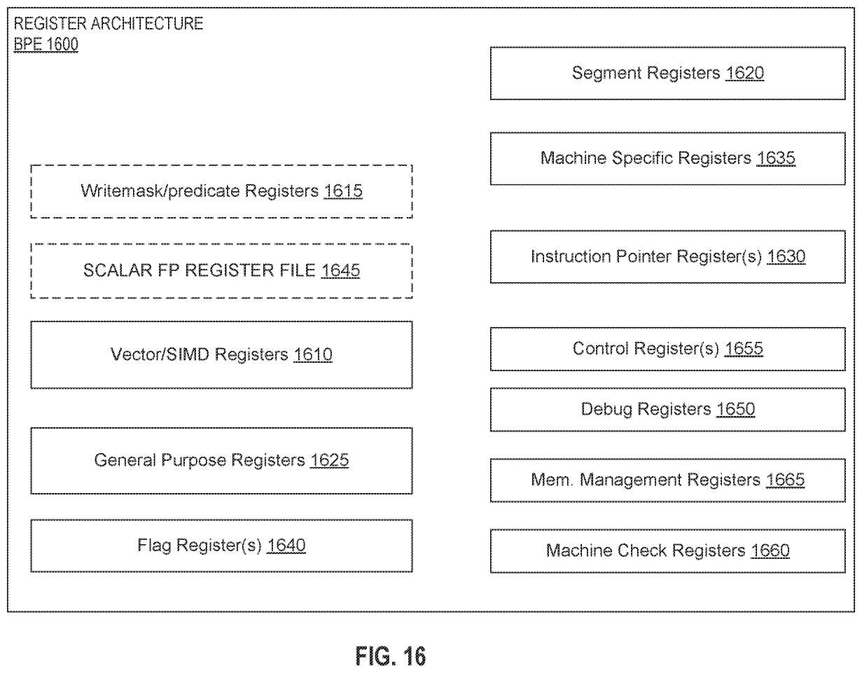

FIG. 17 illustrates examples of the addressing information field 1705. In this illustration, an optional MOD R/M byte 1702 and an optional Scale, Index, Base (SIB) byte 1704 are shown. The MOD R/M byte 1702 and the SIB byte 1704 are used to encode up to two operands of an instruction, each of which is a direct register or effective memory address. Note that both of these fields are optional in that not all instructions include one or more of these fields. The MOD R/M byte 1702 includes a MOD field 1742, a register (reg) field 1744, and R/M field 1746.

The content of the MOD field 1742 distinguishes between memory access and non-memory access modes. In some examples, when the MOD field 1742 has a binary value of 11 (11b), a register-direct addressing mode is utilized, and otherwise a register-indirect addressing mode is used.

The register field 1744 may encode either the destination register operand or a source register operand or may encode an opcode extension and not be used to encode any instruction operand. The content of register field 1744, directly or through address generation, specifies the locations of a source or destination operand (either in a register or in memory). In some examples, the register field 1744 is supplemented with an additional bit from a prefix (e.g., prefix 1101) to allow for greater addressing.

The R/M field 1746 may be used to encode an instruction operand that references a memory address or may be used to encode either the destination register operand or a source register operand. Note the R/M field 1746 may be combined with the MOD field 1742 to dictate an addressing mode in some examples.

The SIB byte 1704 includes a scale field 1752, an index field 1754, and a base field 1756 to be used in the generation of an address. The scale field 1752 indicates a scaling factor. The index field 1754 specifies an index register to use. In some examples, the index field 1754 is supplemented with an additional bit from a prefix (e.g., prefix 1101) to allow for greater addressing. The base field 1756 specifies a base register to use. In some examples, the base field 1756 is supplemented with an additional bit from a prefix (e.g., prefix 1101) to allow for greater addressing. In practice, the content of the scale field 1752 allows for the scaling of the content of the index field 1754 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1107 provides this value. Additionally, in some examples, a displacement factor usage is encoded in the MOD field of the addressing information field 1705 that indicates a compressed displacement scheme for which a displacement value is calculated and stored in the displacement field 1107.

In some examples, the immediate value field 1109 specifies an immediate value for the instruction. An immediate value may be encoded as a 1-byte value, a 2-byte value, a 4-byte value, etc.

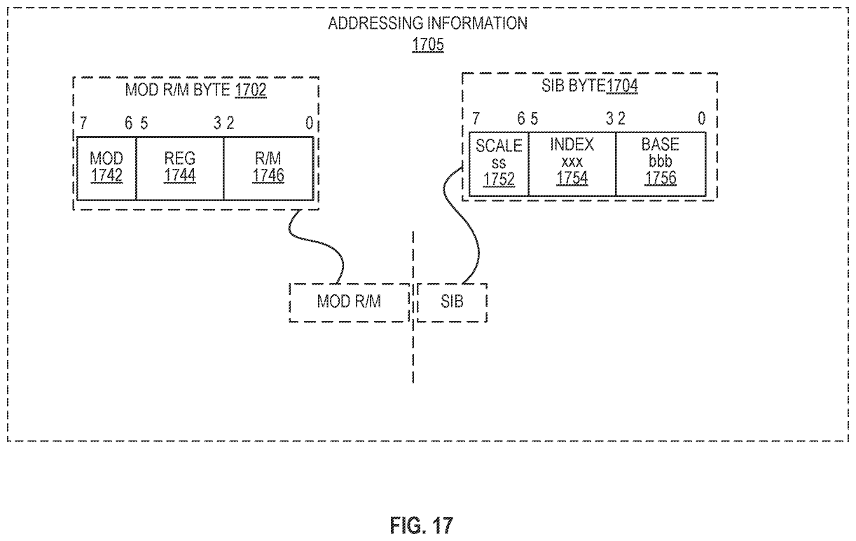

FIG. 18 illustrates examples of a first prefix 1101(A). In some examples, the first prefix 1101(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1101(A) may specify up to three registers using 3-bit fields depending on the format: 1) using the reg field 1744 and the R/M field 1746 of the MOD R/M byte 1702; 2) using the MOD R/M byte 1702 with the SIB byte 1704 including using the reg field 1744 and the base field 1756 and index field 1754; or 3) using the register field of an opcode.

In the first prefix 1101(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (24) registers to be addressed, whereas the MOD R/M reg field 1744 and MOD R/M R/M field 1746 alone can each only address 8 registers.

In the first prefix 1101(A), bit position 2 (R) may be an extension of the MOD R/M reg field 1744 and may be used to modify the MOD R/M reg field 1744 when that field encodes a general-purpose register, a 64-bit packed data register (e.g., a SSE register), or a control or debug register. R is ignored when MOD R/M byte 1702 specifies other registers or defines an extended opcode.

Bit position 1 (X) may modify the SIB byte index field 1754.

Bit position 0 (B) may modify the base in the MOD R/M R/M field 1746 or the SIB byte base field 1756; or it may modify the opcode register field used for accessing general purpose registers (e.g., general purpose registers 1625).

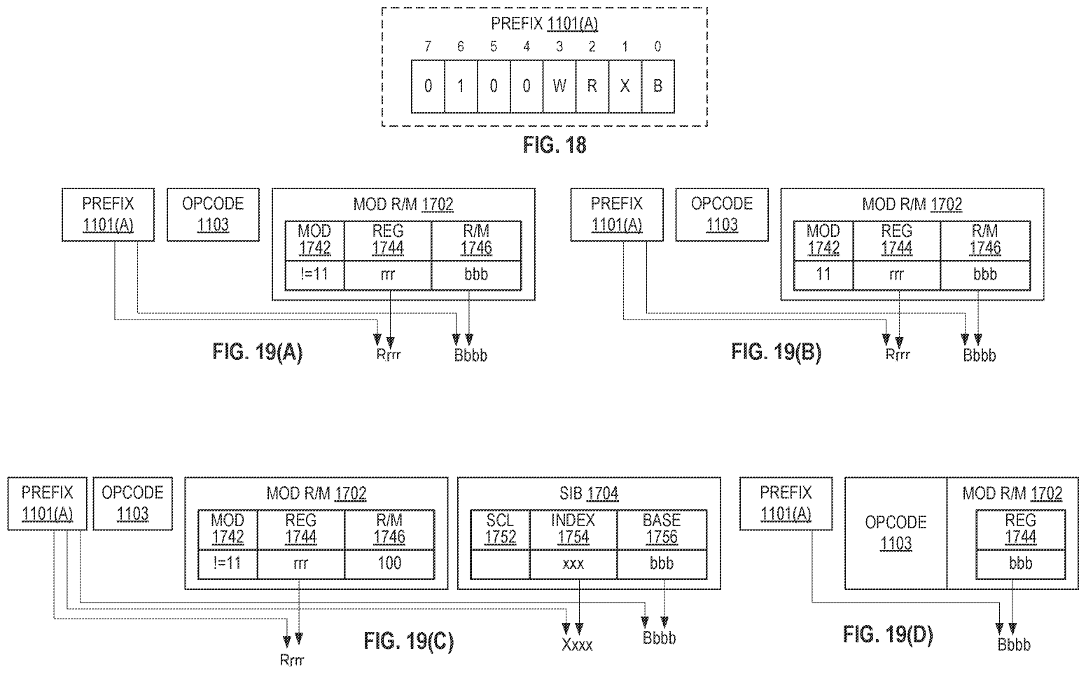

FIGS. 19(A)-(D) illustrate examples of how the R, X, and B fields of the first prefix 1101(A) are used. FIG. 19(A) illustrates R and B from the first prefix 1101(A) being used to extend the reg field 1744 and R/M field 1746 of the MOD R/M byte 1702 when the SIB byte 1704 is not used for memory addressing. FIG. 19(B) illustrates R and B from the first prefix 1101(A) being used to extend the reg field 1744 and R/M field 1746 of the MOD R/M byte 1702 when the SIB byte 1704 is not used (register-register addressing). FIG. 19(C) illustrates R, X, and B from the first prefix 1101(A) being used to extend the reg field 1744 of the MOD R/M byte 1702 and the index field 1754 and base field 1756 when the SIB byte 1704 being used for memory addressing. FIG. 19(D) illustrates B from the first prefix 1101(A) being used to extend the reg field 1744 of the MOD R/M byte 1702 when a register is encoded in the opcode 1103.

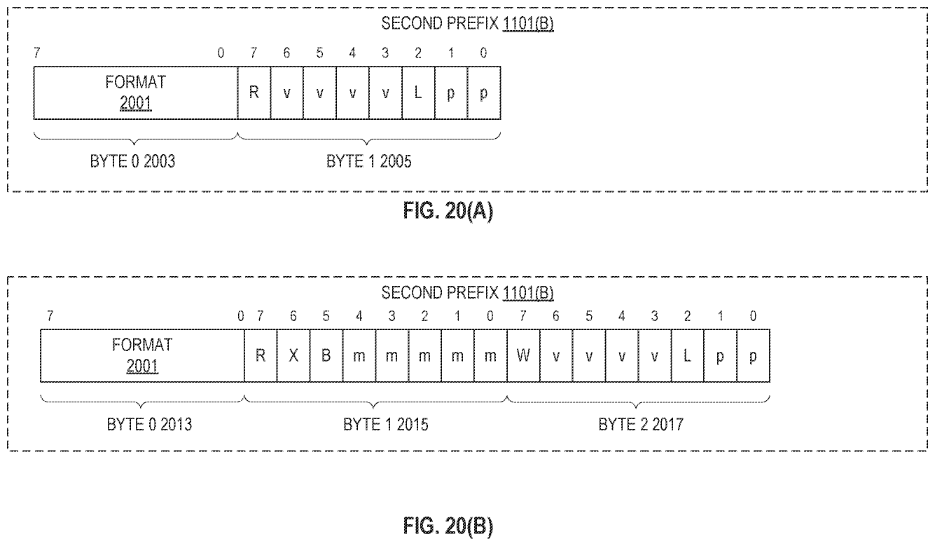

FIGS. 20(A)-(B) illustrate examples of a second prefix 1101(B). In some examples, the second prefix 1101(B) is an example of a VEX prefix. The second prefix 1101(B) encoding allows instructions to have more than two operands, and allows SIMD vector registers (e.g., vector/SIMD registers 1610) to be longer than 64-bits (e.g., 128-bit and 256-bit). The use of the second prefix 1101(B) provides for three-operand (or more) syntax. For example, previous two-operand instructions performed operations such as A=A+B, which overwrites a source operand. The use of the second prefix 1101(B) enables operands to perform nondestructive operations such as A=B+C.

In some examples, the second prefix 1101(B) comes in two forms-a two-byte form and a three-byte form. The two-byte second prefix 1101(B) is used mainly for 128-bit, scalar, and some 256-bit instructions; while the three-byte second prefix 1101(B) provides a compact replacement of the first prefix 1101(A) and 3-byte opcode instructions.

FIG. 20(A) illustrates examples of a two-byte form of the second prefix 1101(B). In one example, a format field 2001 (byte 0 2003) contains the value C5H. In one example, byte 1 2005 includes an “R” value in bit [7]. This value is the complement of the “R” value of the first prefix 1101(A). Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3] shown as vvvv may be used to: 1) encode the first source register operand, specified in inverted (1s complement) form and valid for instructions with 2 or more source operands; 2) encode the destination register operand, specified in Is complement form for certain vector shifts; or 3) not encode any operand, the field is reserved and should contain a certain value, such as 1111b.

Instructions that use this prefix may use the MOD R/M R/M field 1746 to encode the instruction operand that references a memory address or encode either the destination register operand or a source register operand.

Instructions that use this prefix may use the MOD R/M reg field 1744 to encode either the destination register operand or a source register operand, or to be treated as an opcode extension and not used to encode any instruction operand.

For instruction syntax that support four operands, vvvv, the MOD R/M R/M field 1746 and the MOD R/M reg field 1744 encode three of the four operands. Bits [7:4] of the immediate value field 1109 are then used to encode the third source register operand.

FIG. 20(B) illustrates examples of a three-byte form of the second prefix 1101(B). In one example, a format field 2001 (byte 0 2013) contains the value C4H. Byte 1 2015 includes in bits [7:5] “R,” “X,” and “B” which are the complements of the same values of the first prefix 1101(A). Bits [4:0] of byte 1 2015 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit [7] of byte 2 2017 is used similar to W of the first prefix 1101(A) including helping to determine promotable operand sizes. Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3], shown as vvvv, may be used to: 1) encode the first source register operand, specified in inverted (Is complement) form and valid for instructions with 2 or more source operands; 2) encode the destination register operand, specified in Is complement form for certain vector shifts; or 3) not encode any operand, the field is reserved and should contain a certain value, such as 1111b.

Instructions that use this prefix may use the MOD R/M R/M field 1746 to encode the instruction operand that references a memory address or encode either the destination register operand or a source register operand.

Instructions that use this prefix may use the MOD R/M reg field 1744 to encode either the destination register operand or a source register operand, or to be treated as an opcode extension and not used to encode any instruction operand.

For instruction syntax that support four operands, vvvv, the MOD R/M R/M field 1746, and the MOD R/M reg field 1744 encode three of the four operands. Bits [7:4] of the immediate value field 1109 are then used to encode the third source register operand.

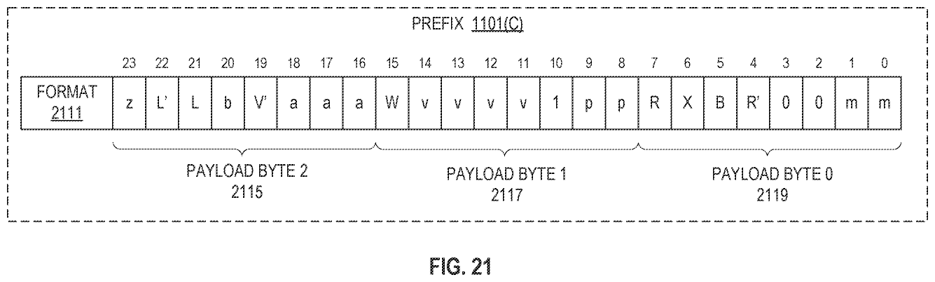

FIG. 21 illustrates examples of a third prefix 1101(C). In some examples, the third prefix 1101(C) is an example of an EVEX prefix. The third prefix 1101(C) is a four-byte prefix.

The third prefix 1101(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 16) or predication utilize this prefix. Opmask register allow for conditional processing or selection control. Opmask instructions, whose source/destination operands are opmask registers and treat the content of an opmask register as a single value, are encoded using the second prefix 1101(B).

The third prefix 1101(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1101(C) is a format field 2111 that has a value, in one example, of 62H. Subsequent bytes are referred to as payload bytes 2115-2119 and collectively form a 24-bit value of P[23:0] providing specific capability in the form of one or more fields (detailed herein).

In some examples, P[1:0] of payload byte 2119 are identical to the low two mm bits. P[3:2] are reserved in some examples. Bit P[4] (R′) allows access to the high 16 vector register set when combined with P[7] and the MOD R/M reg field 1744. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1744 and MOD R/M R/M field 1746. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in Is complement form for certain vector shifts; or 3) not encode any operand, the field is reserved and should contain a certain value, such as 1111b.

P[15] is similar to W of the first prefix 1101(A) and second prefix 1101(B) and may serve as an opcode extension bit or operand size promotion.

P[18:16] specify the index of a register in the opmask (writemask) registers (e.g., writemask/predicate registers 1615). In one example, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1101(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination |
| | | | reg | | or Source |
| VVVV | V′ | vvvv | | GPR, Vector | 2nd Source or |
| | | | | | Destination |
| RM | X | B | MOD R/M | GPR, Vector | 1st Source or |
| | | | R/M | | Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

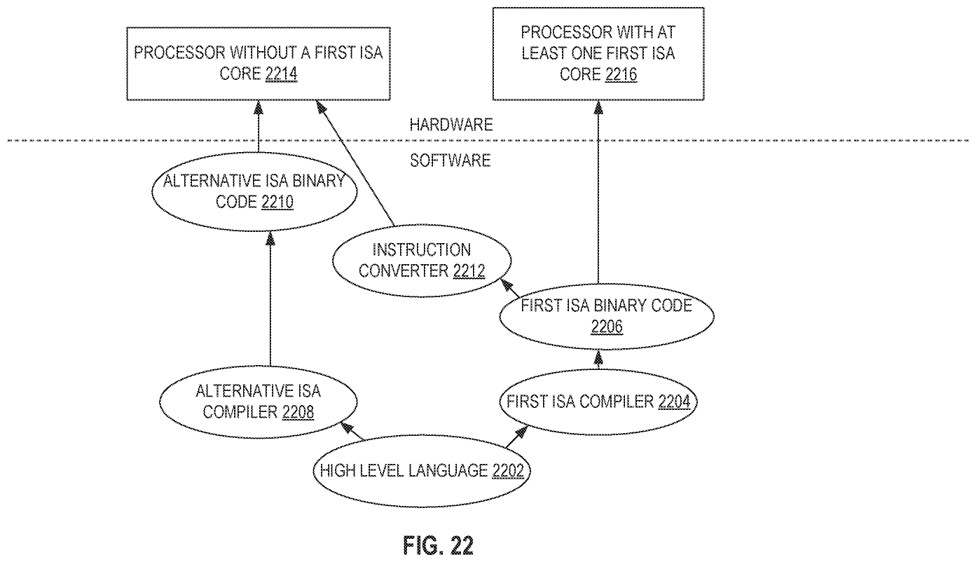

FIG. 22 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 22 shows a program in a high-level language 2202 may be compiled using a first ISA compiler 2204 to generate first ISA binary code 2206 that may be natively executed by a processor with at least one first ISA core 2216. The processor with at least one first ISA core 2216 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 2204 represents a compiler that is operable to generate first ISA binary code 2206 (e.g., object code) that can, with or without additional linkage processing, be executed on the processor with at least one first ISA core 2216. Similarly, FIG. 22 shows the program in the high-level language 2202 may be compiled using an alternative ISA compiler 2208 to generate alternative ISA binary code 2210 that may be natively executed by a processor without a first ISA core 2214. The instruction converter 2212 is used to convert the first ISA binary code 2206 into code that may be natively executed by the processor without a first ISA core 2214. This converted code is not necessarily to be the same as the alternative ISA binary code 2210; however, the converted code will accomplish the general operation and be made up of instructions from the alternative ISA. Thus, the instruction converter 2212 represents software, firmware, hardware, or a combination thereof that, through emulation, simulation or any other process, allows a processor or other electronic device that does not have a first ISA processor or core to execute the first ISA binary code 2206.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

### Examples

Illustrative examples of the technologies disclosed herein are provided below. An embodiment of the technologies may include any one or more, and any combination of, the examples described below.

Example 1 is an apparatus comprising a compute engine and a compute engine control block. The compute engine comprising an array of tiles. Each tile comprising one or more compute elements. Each tile including a connection to one or more other tiles comprising a network. The compute engine control block to manage instruction dispatch across all tiles in the array of tiles and to decompose a load of a large data word into smaller load requests for each of a plurality of memory channels.

Example 2 includes the apparatus of Example 1, optionally the compute elements to perform polynomial operations on polynomials, the polynomials including a plurality of coefficients, the coefficients distributed across the array of tiles.

Example 3 includes the apparatus of Example 1, optionally further comprising the plurality of memory channels.

Example 4 includes the apparatus of Example 3, optionally the compute engine control block is to ensure the tiles in the compute engine operate in lockstep to enable synchronization free communication between the tiles.

Example 5 includes the apparatus of Example 4, optionally the compute engine control block is to use a completion signal received from each of the plurality of memory channels to access a completion state of the load of the large data word.

Example 6 includes the apparatus of Example 3, optionally the compute engine control block is to decompose a store of a large data word into smaller store requests for each of the plurality of memory channels.

Example 7 includes the apparatus of Example 6, optionally the compute engine control block is to use a completion signal received from each of the plurality of memory channels to access a completion state of the store of the large data word.

Example 8 includes the apparatus of Example 1, optionally the compute engine is to perform Fully Homomorphic Encryption (FHE).

Example 9 is a system comprising a fully homomorphic encryption accelerator and a memory. The fully homomorphic encryption accelerator including a compute engine, a compute engine control block and a scratch pad memory. The compute engine comprising an array of tiles, each tile comprising one or more compute elements, each tile including a connection to one or more other tiles comprising a network. The compute engine control block to manage instruction dispatch across all tiles in the array of tiles and to ensure the tiles in the compute engine operate in lockstep to enable synchronization free communication between the tiles. The scratch pad memory to store coefficients to be used by a plurality of compute elements to perform polynomial operations on polynomials. The memory to store data to be processed by the fully homomorphic encryption accelerator.

Example 10 includes the system of Example 9, optionally the polynomials include a plurality of coefficients, the coefficients distributed across the array of tiles.

Example 11 includes the system of Example 9, optionally the memory comprises a plurality of memory channels.

Example 12 includes the system of Example 11, optionally the compute engine control block is to decompose a load of a large data word into smaller load requests for each of the plurality of memory channels.

Example 13 includes the system of Example 12, optionally the compute engine control block is to use a completion signal received from each of the plurality of memory channels to access a completion state of the load of the large data word.

Example 14 includes the system of Example 11, optionally the compute engine control block is to decompose a store of a large data word into smaller store requests for each of the plurality of memory channels.

Example 15 includes the system of Example 14, optionally the compute engine control block is to use a completion signal received from each of the plurality of memory channels to access a completion state of the store of the large data word.

Example 16 is a method comprising performing, by a compute engine control block, instruction dispatch across all tiles in an array of tiles in a compute engine, each tile comprising one or more compute elements, each tile including a connection to one or more other tiles comprising a network. The method also includes managing, by the compute engine control block, the instruction dispatch to ensure the tiles in the compute engine operate in lockstep to enable synchronization free communication between the tiles.

Example 17 includes the method of Example 16, optionally the compute elements is to perform polynomial operations on polynomials, the polynomials including a plurality of coefficients, the coefficients distributed across the array of tiles.

Example 18 includes the method of Example 16, optionally the compute engine control block is to decompose a load of a large data word into smaller load requests for each of a plurality of memory channels.

Example 19 includes the method of Example 18, optionally the compute engine control block is to use a completion signal received from each of the plurality of memory channels to access a completion state of the load of the large data word.

Example 20 includes the method of Example 16, optionally the compute engine control block is to decompose a store of a large data word into smaller store requests for each of a plurality of memory channels. The compute engine control block is to use a completion signal received from each of the plurality of memory channels to access a completion state of the store of the large data word.

Example 21 is at least one machine readable medium that includes a plurality of instructions that in response to being executed by a system can cause the system to carry out a method according to any one of examples 16 to 20.

Example 22 is an apparatus that includes means for performing the methods of any one of examples 16 to 20.

What is claimed is:

1. An apparatus comprising:
a compute engine comprising an array of tiles, each tile comprising one or more compute elements, each tile including a connection to one or more other tiles comprising a network; and
a compute engine control block to manage instruction dispatch across all tiles in the array of tiles and to decompose a load of a large data word into smaller load requests for each of a plurality of memory channels.

2. The apparatus of claim 1, wherein the compute elements to perform polynomial operations on polynomials, the polynomials including a plurality of coefficients, the coefficients distributed across the array of tiles.

3. The apparatus of claim 1, further comprising the plurality of memory channels.

4. The apparatus of claim 3, wherein the compute engine control block is to ensure the tiles in the compute engine operate in lockstep to enable synchronization free communication between the tiles.

5. The apparatus of claim 4, wherein the compute engine control block is to use a completion signal received from each of the plurality of memory channels to access a completion state of the load of the large data word.

6. The apparatus of claim 3, wherein the compute engine control block is to decompose a store of a large data word into smaller store requests for each of the plurality of memory channels.

7. The apparatus of claim 6, wherein the compute engine control block is to use a completion signal received from each of the plurality of memory channels to access a completion state of the store of the large data word.

8. The apparatus of claim 1, wherein the compute engine is to perform Fully Homomorphic Encryption (FHE).

9. A system comprising:
a fully homomorphic encryption accelerator comprising:
a compute engine comprising an array of tiles, each tile comprising one or more compute elements, each tile including a connection to one or more other tiles comprising a network; and
a compute engine control block to manage instruction dispatch across all tiles in the array of tiles and to ensure the tiles in the compute engine operate in lockstep to enable synchronization free communication between the tiles; and
scratch pad memory to store coefficients to be used by a plurality of compute elements to perform polynomial operations on polynomials; and
memory to store data to be processed by the fully homomorphic encryption accelerator.

10. The system of claim 9, wherein the polynomials include a plurality of coefficients, the coefficients distributed across the array of tiles.

11. The system of claim 9, wherein the memory comprises a plurality of memory channels.

12. The system of claim 11, wherein the compute engine control block is to decompose a load of a large data word into smaller load requests for each of the plurality of memory channels.

13. The system of claim 12, wherein the compute engine control block is to use a completion signal received from each of the plurality of memory channels to access a completion state of the load of the large data word.

14. The system of claim 11, wherein the compute engine control block is to decompose a store of a large data word into smaller store requests for each of the plurality of memory channels.

15. The system of claim 14, wherein the compute engine control block is to use a completion signal received from each of the plurality of memory channels to access a completion state of the store of the large data word.

16. A method comprising:
performing, by a compute engine control block, instruction dispatch across all tiles in an array of tiles in a compute engine, each tile comprising one or more compute elements, each tile including a connection to one or more other tiles comprising a network; and
managing, by the compute engine control block, the instruction dispatch to ensure the tiles in the compute engine operate in lockstep to enable synchronization free communication between the tiles.

17. The method of claim 16, wherein the compute elements is to perform polynomial operations on polynomials, the polynomials including a plurality of coefficients, the coefficients distributed across the array of tiles.

18. The method of claim 16, wherein the compute engine control block is to decompose a load of a large data word into smaller load requests for each of a plurality of memory channels.

19. The method of claim 18, wherein the compute engine control block is to use a completion signal received from each of the plurality of memory channels to access a completion state of the load of the large data word.

20. The method of claim 16, wherein the compute engine control block is to decompose a store of a large data word into smaller store requests for each of a plurality of memory channels, the compute engine control block is to use a completion signal received from each of the plurality of memory channels to access a completion state of the store of the large data word.
